(19) United States
(12) Patent Application Publication
(10) Pub. No.: US 2002/0174272 A1
(43) Pub. Date: Nov. 21, 2002

(54) DMA controller and automatic DMA controller generating apparatus

(76) Inventors: Dai Fujii, Hitachi (JP); Ryo Fujita, Hitachi (JP); Hiromichi Yamada, Hitachi (JP); Koutarou Shimamura, Hitachinaka (JP); Teppei Hirotsu, Hitachi (JP); Kesami Hagiwara, Higashiyamato (JP); Hideyuki Hara, Kodaira (JP); Takashi Hotta, Hitachi (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/960,289

(22) Filed: Sep. 24, 2001

(30) Foreign Application Priority Data
May 21, 2001 (JP) 2001-151586

(51) Int. Cl. G06F 13/28

(52) U.S. Cl. 710/22

(57) ABSTRACT

In a DMA controller having such a structure capable of readily changing a total channel number, a channel number depending unit for handling a signal related to the total channel number; an instance capable unit which can be repeatedly used plural times equal to the total channel number; and also a channel number not-depending unit are extracted from the respective functions of the DAM controller. Then, these extracted units are combined with each other so as to constitute a functional block of the DMA controller circuit. In such a case that a total device number is changed, since only the channel number depending unit may be merely corrected, a total number of correcting stages can be reduced. The reuse rate of the channel number not-depending unit may be increased.

### BACKGROUND OF THE INVENTION

1. Field of the Invention

The present invention is related to a DMA controller and an automatic DMA controller generating apparatus. More specifically, the present invention is directed to a structure of a DMA controller capable of readily changing a channel number, and also directed to a means for automatically changing an external device number and a peripheral device number of this DMA controller.

2. Description of the Related Art

A DMA controller (simply referred to as a “DMAC (Direct Memory Access Controller)” hereinafter) corresponds to such a circuit for executing a data transfer operation between a device connected to either an external bus or an internal bus and a memory area without receiving any interference caused by a central processing unit (CPU). In accordance with such a DMA controller, since this DMA controller need not transfer data one by one in accordance with an interrupt process of the CPU, the data transfer operation can be carried out in high speeds.

Normally, a DMA controller owns a plurality of independently programmable channels. While devices are connected to the respective channels, the DMA controller can simultaneously process data transfer requests which are issued from these devices of the respective channels.

This sort of conventional DMA controller circuit is described in, for example, JP-A-7-21117 and U.S. Pat. No. 6,065,070.

In a system-on-chip (SOC) capable of realizing various sorts of circuits by employing one chip (single chip), while the respective circuits which are described by using a hardware description language (HDL) are made in the form of components, these components are united to realize an entire chip. As such component-formed circuits, there are two components, namely, a component called as a “hard core”, and another component called as a “soft core”. In the hard-core component, a physical shape (mask layout) is fixed. In the soft-core component, a physical shape is not fixed. Nowadays, soft-core components may become major.

In such a case that DMA controllers are reused as a soft core in various sorts of chips, since plural devices used in correspondence with application programs are connected to the respective chips, these DMA controllers to which these devices are connected should easily change a total number of devices.

FIG. 1 is a diagram for showing data paths of signal lines related to a total device number in a conventional DMA controller. A plurality of signal lines used to request data transfer operations are connected from external devices 100 which are connected to an external bus to a request selector circuit 102, and a total number of these signal lines is equal to (total external device number “Z”+1). Similarly, a plurality of signal lines used to request data transfer operations are connected from peripheral devices 101 which are connected to a peripheral bus to this request selector circuit 102, and a total number of these signal lines is equal to (total peripheral device number “M”+1).

Request signal lines for plural channels, the total number of which is equal to the total number of these external devices 100, are connected from the request selector circuit 102 to the request priority encoder circuit 103, and furthermore, are connected to an acknowledge circuit 104. The request priority encoder circuit 103 selects such a request having a high priority order.

A plurality of acknowledge signal lines with respect to plural requests, the total number of which is equal to both the total external device number and the total peripheral device number, are derived from the acknowledge circuit 104, and then, are connected to the external devices 100 and the peripheral devices 101.

Similarly, a plurality of signal lines, the total number of which is equal to the total channel number, are connected to a control register circuit 105 containing various sorts of control registers of this conventional DMA controller, a control register selector circuit 106 for selecting the control registers, and a control register RD/WR circuit 107 for executing RD/WR (read/write) operations with respect to the control registers.

In the conventional DMA controller, the circuits which handle/process the signals related to the total channel number are distributed in the respective functional blocks 108 to 112. These circuits correspond to the request selector circuit 102, the request priority encoder circuit 103, the acknowledge circuit 104, the control register circuit 105, the control register selector circuit 106, the control register RD/WR circuit 107, and so on. As a consequence, in such a case that a total number of external devices which are connected to a chip is changed, these plural functional blocks are required to be corrected.

Also, even when such a functional block which does not depend upon the total channel number is reused, the reuse rate thereof is low, and also, a large number of correction stages are necessarily required in order to change the total number of these external devices.

### SUMMARY OF THE INVENTION

A first object of the present invention is to provide a DMA controller equipped with a structure capable of easily changing a total number of channels.

A second object of the present invention is to provide both an automatic DMA controller generating method and also an automatic DMA controller generating apparatus equipped with a means capable of automatically changing both a total number of external devices and a total number of peripheral devices of a DMA controller.

To achieve the above-explained first object, a DMA controller, according to an aspect of the present invention, is featured by such a DMA controller for transferring data between a device connected to either an external bus or an internal bus, and a memory area, comprising: a channel number depending circuit block for handling a signal related to the number of channels in the case that both a data transfer request signal sent from the device and a data transfer acknowledge signal corresponding to an response signal thereof are connected; an instance capable circuit block which can be repeatedly used plural times equal to a total number of the channels; and a channel number not-depending circuit block.

The channel number depending circuit block includes: a request priority encoder circuit for selecting a request of a channel whose priority order is high; an acknowledge output circuit of controlling the data transfer acknowledge signal; a selector circuit for selecting either a data bus or a control signal, which depends upon the channel number; a state machine circuit for controlling a data access operation with respect to a control register employed in the DMA controller; a decoder circuit for decoding an address bus signal when the data access operation is carried out; and a DMA operation register circuit for controlling an entire circuit of the DMA controller.

The instance capable circuit block includes: a request selector circuit for selecting one of the data transfer request signals issued from a plurality of devices as a signal used for a DMA transfer operation; and a control register group of the DMA controllers which are required, the total number of which is equal to the total channel numbers.

The control register group of the DMA controller is comprised of: a channel control register for controlling a data transfer operation of the DMA controller with respect to each of the channels; a transfer time register for decrementing of the DMA controller so as to count the data transfer time; a source address register for representing a transfer source address used in the data transfer operation of the DMA controller; and a destination address register for representing a transfer destination address used in the data transfer operation of the DMA controller.

In any one of the DMA controllers, the channel number depending circuit block includes: a register for temporarily holding data which is read from a transfer source during the DMA transfer operation; a state machine circuit for controlling the data transfer operation of the DMA controller; an address offset decoder circuit for determining an address increase amount of a transfer source address and an address increase amount of a transfer destination address during the DMA transfer operation; an adder for calculating both a transfer source address and a transfer destination address during the DMA transfer operation; a decrementer for decrementing a data transfer time of the DMA controller; and a comparator for comparing a content of the transfer time register with “0” in order to assert a transfer end interrupt of the DMA controller.

Also, in order to achieve the second object, a DMA controller generating method, according to another aspect of the present invention, is featured by such a method for generating a DMA controller used to transfer data between a device connected to either an external bus or an internal bus and a memory area, wherein: a channel number depending unit for handling a signal related to the number of channels is extracted from each functional block of a component data logic file of a DMA controller; an instance capable unit which can be repeatedly used plural times equal to a total number of the channels is extracted; a channel number not-depending unit is extracted; and a logic file of the channel number depending unit, a logic file of the instance capable unit, a logic file of the channel number not-depending unit are coupled to each other so as to generate a logic file of said DMA controller.

When the DMA controller is arranged in this manner, in such a case that a total number of the external devices connected to a chip is changed, only the channel number depending unit is merely corrected. As a result, the entire manufacturing stage of the DMA controller required to change a total number of these external devices can be reduced.

Further, in order to achieve the above-described second object, an automatic DMA controller generating apparatus, according to another aspect of the present invention, is featured by such an apparatus for generating a DMA controller used to transfer data between a device connected to either an external bus or an internal bus and a memory area, comprising: a parameter input apparatus equipped with a user interface used to enter either a total number of channels, or a total number of devices of a DMA controller which are wanted to be automatically generated; a file storage apparatus for storing thereinto logic files of component data of each of circuits and a generated logic file; and a component coupling apparatus for coupling the logic files of the component data with each other based upon input information from the parameter input apparatus so as to automatically generate a logic file of the DMA controller.

Concretely speaking, the logic file stored in the file storage apparatus corresponds to logic files of the above-described respective DMA controller circuits, and also corresponds to such a logic file which has been previously formed as to plural sorts of channel numbers with respect to the channel number depending circuit.

In addition, a DMA controller generating apparatus, according to a further aspect of the present invention, is featured by such an apparatus for generating a DMA controller used to transfer data between a device connected to either an external bus or an internal bus and a memory area, comprising: a parameter input apparatus equipped with a user interface used to enter either a total number of channels, or a total number of devices of a DMA controller which are wanted to be automatically generated; a file storage apparatus for storing thereinto both logic files of component data of each of circuits and also a script file which automatically generates a logic file; a component coupling apparatus for coupling the logic files of the component data with each other based upon input information from the parameter input apparatus so as to automatically generate a logic file of the DMA controller; and a component correcting apparatus for automatically generating a logic file from a script file based upon input information from the parameter input apparatus.

The logic file stored in the file storage apparatus corresponds to logic files of the above-described respective DMA controller circuits, and also corresponds to such a script file by which a logic file is automatically formed with respect to the channel number depending circuit.

In any one of the above-described automatic DMA controller generating apparatus, the parameter input apparatus is comprised of: a GUI screen for designating a total number of devices which request to transfer data; another GUI screen for causing signal lines between the devices and the DMA controllers to be related to each other; and another GUI screen for setting priority orders of such channels which accept data transfer requests.

In this case, the DMA controller generating apparatus is further comprised of: an interface generating apparatus for automatically generating a logic file of the interface circuit between the device and the DMA controller based upon the relationship information of the signal lines between the device and the DMA controller, which is entered from the parameter input apparatus.

The GUI screen for setting the priority orders of the channels which accept the data transfer requests is equipped with: selection means capable of setting such a condition that a data transfer request of such a device owns a higher priority order, the device being connected to a channel whose channel number is large, whereas a data transfer request of such a device owns a higher priority order, the device being connected to a channel whose channel number is small.

In any one of the above-explained automatic DMA controller generating apparatus, the parameter input apparatus owns a logic file of a request priority encoder circuit in response to a total sort number of the priority orders of the channels which are provided on the GUI screen for setting the priority orders of the channels which accept the data transfer requests.

Also, in the GUI screen for causing the signal lines between the deices and the DMA controllers to be related to each other, names of signal lines provided on the side of the DMA controller are described in a descent order in accordance with a display order of a input column into which signal lines provided on the side of the devices are entered.

In accordance with either the automatic DMA controller generating method or the automatic DMA controller generating apparatus according to the present invention, such a DMA controller in which a total number of the external devices and also a total number of the peripheral devices are changed can be automatically generated.

### BRIEF DESCRIPTION OF THE DRAWINGS

FIG. 1 is a schematic block diagram for showing the data paths of the signal lines related to the device number in the conventional DMA controller;

FIG. 2 is a schematic block diagram for representing an example of an internal structure of a chip to which a DMA controller of the present invention is applied;

FIG. 3 is a schematic diagram for indicating an internal arrangement of an instance capable unit 301;

FIG. 4 is a schematic block diagram for showing an internal structure of an instance capable unit 301;

FIG. 5 is a diagram for explaining a bit allocation executed in a register of a channel control register 401;

FIG. 6 is a diagram for showing an example of an HDL program of a request selector circuit 400 in the case that a total number (=M+1) of peripheral devices is equal to 7;

FIG. 7 is a schematic block diagram for showing an internal arrangement of a channel number depending unit 300;

FIG. 8 is a diagram for representing a bit allocation executed in a register of a DMA operation register 700;

FIG. 9 is a diagram for indicating an example (MSB priority) of an HDL program of a request priority encoder circuit 701 in such a case that a total number (=Z+1) of external devices is equal to 4;

FIG. 10 is a schematic block diagram for showing an internal arrangement of an acknowledge output circuit 702;

FIG. 11 is a diagram for indicating an example of an HDL program of a peripheral device acknowledge generating circuit 1000 in such a case that a total number (=M+1) of peripheral devices is equal to 7;

FIG. 12 is a diagram for indicating an example of an HDL program of an external device acknowledge generating circuit 1001 in such a case that a total number (=Z+1) of external devices is equal to 4;

FIG. 13 is a schematic block diagram for showing an internal arrangement of a control register selector grouping circuit 703;

FIG. 14 is a schematic block diagram for showing an internal arrangement of a control register RD/WR circuit 704;

FIG. 15 is a diagram for indicating an example of an address map related to a control register in such a case that a total number (=Z+1) of channels is equal to 4;

FIG. 16 is a diagram for indicting an example of an HDL program of a channel decoder circuit 1401;

FIG. 17 is a diagram for indicating an example of an HDL program of an address decoder circuit 1402;

FIG. 18 is a state transition diagram for showing a register RD/WR state machine circuit 1403 described by way of the Mealy type description;

FIG. 19 is a schematic block diagram for indicating an internal arrangement of a channel number not-depending unit 302;

FIG. 20 is a state transition diagram for showing a main sequence of a transfer control state machine circuit 1801, which is described by way of the Mealy type description;

FIG. 21 is a state transition diagram for representing a read command issuing sequence described by way of the Mealy type description in the case that the present state is advanced to a READ state;

FIG. 22 is a state transition diagram for representing a write command issuing sequence described by way of the Mealy type description in the case that the present state is advanced to a WRITE state;

FIG. 23 is a diagram for indicating an example of an HDL program of an address offset decoder circuit 1802;

FIG. 24 is a diagram for representing an example of an HDL program of a top hierarchy of a DMA controller 207;

FIG. 25 is a schematic block diagram for representing a system arrangement of an automatic DMA controller generating apparatus according to an embodiment mode 2 of the present invention;

FIG. 26 is a diagram for indicating a directory structure of component data stored in a file storage apparatus 2501;

FIG. 27 is a diagram for showing an example of a program of a shell command executed by a component coupling apparatus 2502;

FIG. 28 is a schematic block diagram for indicating a system arrangement of an automatic DMA controller generating apparatus according to an embodiment mode 3 of the present invention;

FIG. 29 is a flow chart for describing a process sequence executed by a component correcting apparatus 2803;

FIG. 30 is a diagram for indicating a script example used to generate a logic file of a peripheral device acknowledge generating unit 1000;

FIG. 31 is a diagram for indicating a script example used to generate a logic file of a request selector circuit 400;

FIG. 32 is a schematic block diagram for indicating a system arrangement of an automatic DMA controller generating apparatus according to an embodiment mode 4 of the present invention;

FIG. 33 is a diagram for representing an example of a system environment used to realize the automatic DMA controller generating apparatus of the embodiment mode 4 under suitable condition;

FIG. 34 is a diagram for illustrating an example of a GU screen used to enter both a total number of external devices and a total number of peripheral devices provided by a parameter input apparatus 3200;

FIG. 35 is a diagram for illustrating an example of a GUI screen used to establish a correspondence relationship among signals appeared between devices and the DMA controller, which are provided by the parameter input apparatus 3200;

FIG. 36 is a diagram for indicating an example of an HDL program of an interface circuit between devices generated by an interface circuit generating apparatus 3204 and the DMA controller among the devices and the DMA controller based upon the input information of FIG. 34 and FIG. 35;

FIG. 37 is a diagram for indicating an example of a GUI screen used to designate priority orders of channels provided by the parameter input apparatus 3200;

FIG. 38 is a diagram for representing an example (LSB priority) of an HDL program of a request priority encoder circuit 701 in such a case that a total number (=Z+1) of external devices is equal to 4; and

FIG. 39 is a diagram for shows an example of a program of a shell command used to select a request priority encoder circuit for requesting that LSB owns a priority order, or MSB owns a priority order.

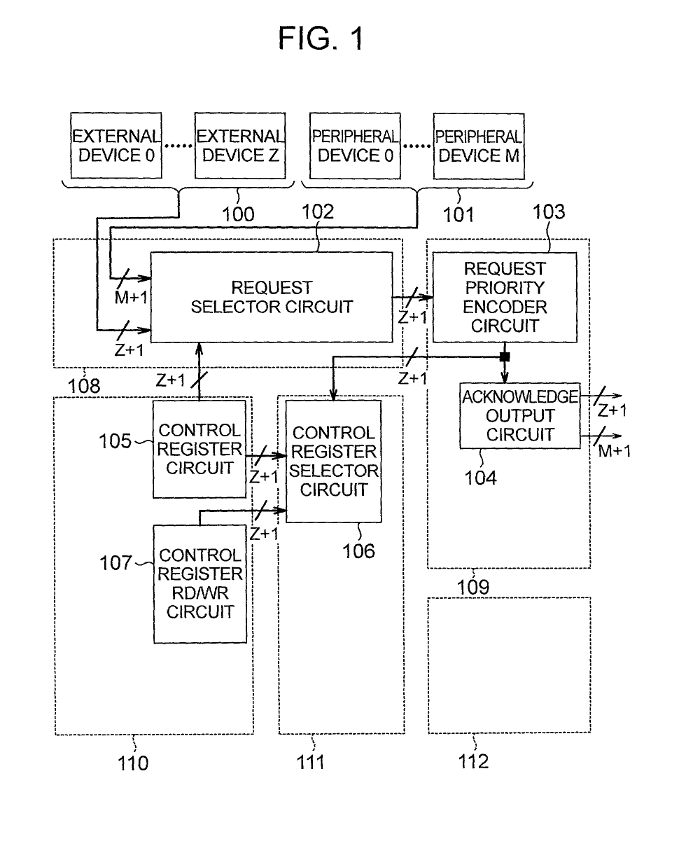

### DETAILED DESCRIPTION OF THE EMBODIMENTS

Embodiment Mode 1

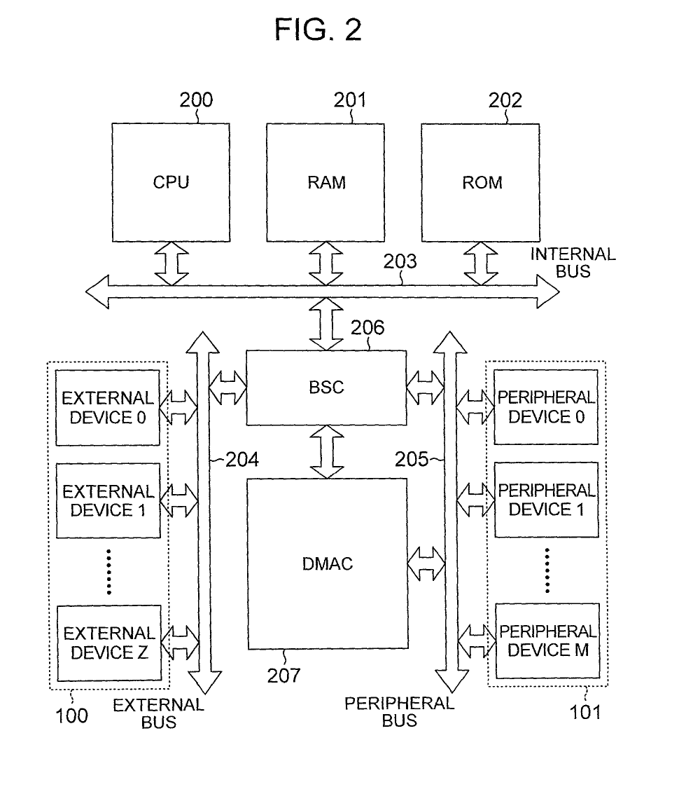

Referring now to FIG. 2 to FIG. 22, an arrangement and operations of a DMA controller according to an embodiment mode 1 of the present invention will be described. This DMA controller is provided with such a structure capable of easily changing a total channel number in order to achieve the above-described first object.

In a program of a hardware descriptive language (HDL) used in this embodiment mode 1, tokens such as “input”, “output”, “wire”, “function”, “endfunction”, “case”, “default”, “endcase”, “assign”, “if”, and “else if” correspond to reserved words of the HDL.

In this embodiment mode 1, these reserved words are used within descriptive blocks of “module” to “endmodule” so as to define a circuit. A “module” statement of the HDL is described in accordance with a syntax rule called as a “module name (port list);.”

Each of port signals contained in the port list is defined by a port declaration located subsequent to the “module” statement.

While a port declaration uses the “input” statement in the case of an input port, whereas a port declaration uses the “output” statement in the case of an output port, the port declaration is described in accordance with the following syntax rule:

input bit-width port signal stream;

output bit-width port signal stream; If no designation is made, then the bit-width is equal to “1.”

A signal appeared inside a circuit, which is defined by the “module” statement is defined by a net declaration located subsequent to a port declaration. The net declaration is described by using the “wire” statement in accordance with a syntax rule referred to as:

wire bit-width internal signal stream; If no designation is made, then the bit-width is equal to “1.”

To describe a combination circuit, both the “function” statement and the “assign” statement are employed. Similar to a function of the C language, in the “function” statement, a return value may be set to a variable of a function name located subsequent to the “function”, and a circuit is described within the description blocks of “function” to “endfunction.”

The “function” statement is described in accordance with the following syntax rule:

function bit-width function-name.

A combination circuit is described in accordance with the following syntax rule:

endfunction.

If no designation is made, then the bit-width is equal to “1.” In the descriptive block of the “function” statement, while using such syntax as “case”, “endcase”, “if”, and “else if”, a combination circuit such as a selector and a decoder is described.

In the “assign” statement, a combination circuit is described by one line of a substitution statement. Also, in the HDL, a circuit defined by the “module” statement may be succeeded (instance) by the below-mentioned instance syntax:

module-name instance-name (net-list);.

In this embodiment mode 1, while the respective syntax is properly used, the present invention is described.

FIG. 2 is a schematic block diagram for showing an example of an internal arrangement of a chip to which the DMA controller of the present invention is applied.

A CPU 200 reads therein a command code from a ROM 202 which stores thereinto a program, and controls an entire arrangement of this chip while the CPU 100 accesses to data stored in a RAM 201. The CPU 200, the RAM 202, and the ROM 201 are connected via an internal bus 203 to each other. An external device 100 and a peripheral device 101 are connected to an external bus 204 and a peripheral bus 205, respectively. These external/peripheral buses 204/205 are connected to a bus control circuit BSC 206. The bus control circuit BSC 206 controls data access operations of the CPU 200 and the DMA controller 207, and also inputs/outputs data of the RAM 201, the ROM 202, the external device 100, and the peripheral device 101 with respect to the respective buses in order that the data do not compete with each other on the respective buses.

The DMA controller 207 supplies a transfer source address to the BSC 206 so as to read therein the data of the external device 100, the peripheral device 101, the RAM 201, and the ROM 202, and also supplies both a transfer destination address and the read data to the BSC 206. The set values used to control the respective sorts of operations of the DMA controller 207 are stored into either the ROM 202 or the RAM 201. The CPU 200 writes data via the peripheral bus 205 and the BSC 206 into the DMA controller 207 in accordance with a program saved in the ROM 202.

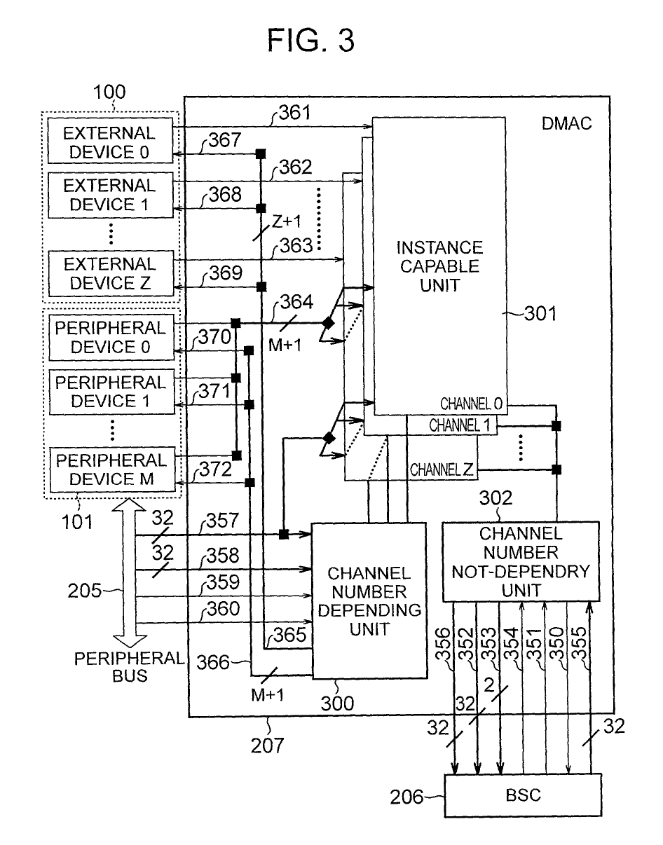

FIG. 3 is a diagram for schematically showing a system structure of a module-to-module interface between the DMA controller 207 and a peripheral module of this DMA controller 207 of this embodiment mode 1.

An internal unit of the DMA controller 207 is subdivided into various functional blocks, namely a channel number depending unit 300, an instance capable unit 301, and a channel number not-depending unit 302.

The channel number depending unit 300, the instance capable unit 301, and the channel number not-depending unit 302 on the logic file correspond to a circuit block which depends upon a channel number, an instance capable circuit block which can be repeatedly used plural times equal to a total channel number, and a circuit block which does not depend upon a total channel number, respectively, in an actual circuit arrangement.

(Z+1) pieces of the external devices 100 are connected via the external bus 204 to this DMA controller 207, and (M+1) pieces of the peripheral devices 101 are connected via the peripheral bus 205 to this DMA controller 207, and also the bus control circuit BSC 206 is connected thereto.

The respective data transfer request signals derived from the external device 100 are connected to the instance capable units 301 of the respective channels employed in the DMA controller 207 one by one. For instance, a data transfer request signal ed_req[0] (361) of an external device “0”, and another data transfer request signal ed_req[Z] (363) of an external device “Z” are connected to the instance capable unit 301 of a channel “0”, and the instance capable unit 301 of another channel “Z”, respectively.

As a consequence, in this embodiment mode 1, a total channel number (quantity) is equal to a total number of external devices, namely (Z+1), and a channel number is equal to a device number of an external device 100 to be connected.

All of data transfer request signals of the peripheral devices 101 are connected to the instance capable circuits 301 of the respective channels employed in the DMA controller 207. For example, data transfer request signals pd_req[M:0](364) of a peripheral device “0” through a peripheral device “M” are connected to the instance capable units 301 of the channel “0” through the channel “Z”, respectively.

Also, as response signals with respect to the data transfer request signal of the external device 100 and the data transfer request signal of the peripheral device 101, data transfer acknowledge signals are connected to the external device 100, and the peripheral device 101, respectively. For instance, a data transfer acknowledge signal dm_edack[0] (367) is connected to an external device “0”, and another data transfer acknowledge signal dm_edack[Z] (369) is connected to another external device “Z.”

A data transfer acknowledge signal dm_pdack[0] (370) is connected to the peripheral device “0”, and another data transfer acknowledge signal dm_pdack[M] (372) is connected to the peripheral device M.

As a signal used to be connected between the BSC 206 and the DMA controller 207, the following signals are provided, namely, a bus right request signal dm_busreq(350) used to transfer a use request of a bus right with respect to the BSC 206; a bus right acknowledge signal ib_dmbusack(351) corresponding to an acknowledge signal for this bus right request signal; a data transfer address signal dm_a[31:0] (352) indicative of an address of either a data transfer source or a data transfer destination; a data transfer command signal dm_cmd[1:0] (353) used to send a read/write command with respect to the BSC 206; a transfer command acknowledge signal ib_dmbusrdy(354) corresponding to an acknowledge signal for the data transfer command signal; a reading data signal ib_dmd[31:0] (355) used to read data from the BSC 206 when the data transfer command signal dm_cmd[1:0] (353) is equal to the read command; and further, a writing data signal dm_d[31:0] (356) used to write data into the BSC 206 when the data transfer command signal dm_cmd[1:0] is equal to the write command.

As a signal used to be connected between the peripheral bus 205 and the DMA controller 207, the following signals are provided; namely, a data bus signal pd[31:0] (357) used to access data via the peripheral bus 205; an address bus signal pa[31:0] (358); a module select signal pms(359) indicating such a fact that the control register of the DMA controller 207 is selected in the case that the CPU 200 accesses the control register of the DMA controller 207; and further, a strobe signal spread(360) indicating such a fact as to whether this access operation corresponds to the reading operation, or the writing operation.

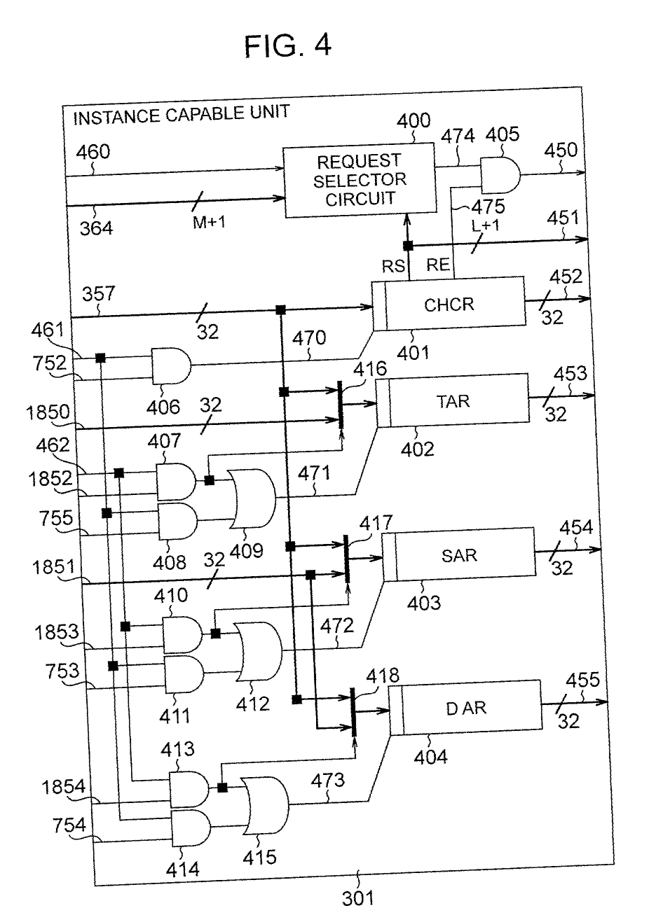

FIG. 4 to FIG. 6 are diagrams related to the instance capable unit 301.

FIG. 4 is a schematic block diagram for showing an internal arrangement of the instance capable unit 301. This instance capable unit 301 is arranged by a request selector circuit 400, a control register group, and several sets of combination circuits (405 to 418). This control register group is constructed of a channel control register 401, a transfer number register 402, a source address register 403, and a destination address register 404.

The instance capable unit 301 is arranged by such circuits which do not depend upon the channel number. The instance capable unit 301 corresponds to a circuit for one channel, and is repeatedly used plural times equal to a total channel number. Each of the control registers shown in FIG. 4 is constituted by a flip-flop equipped with an enable having a 32-bit bit-width.

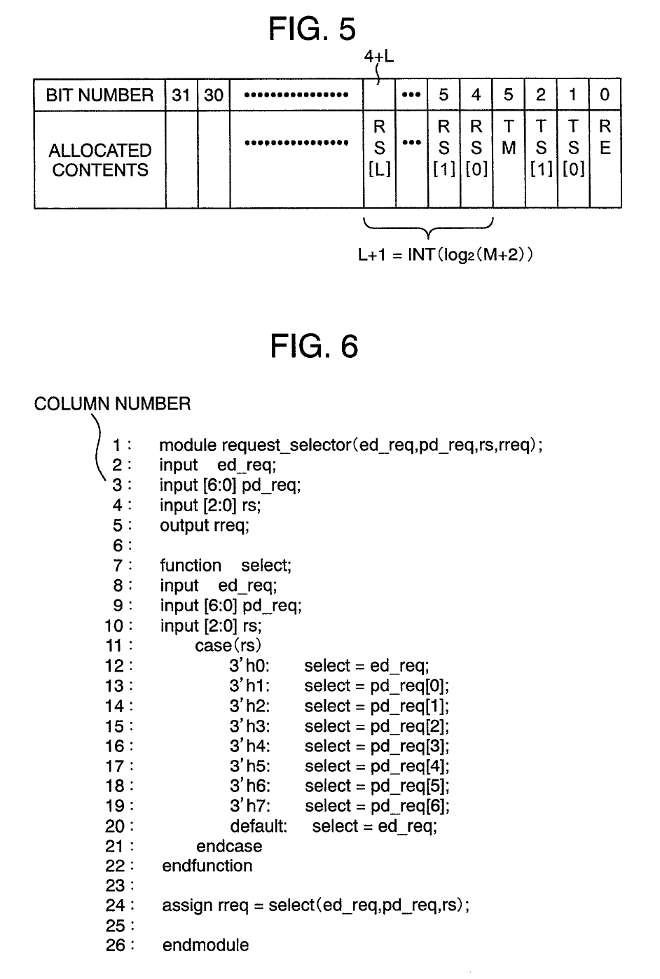

FIG. 5 is a diagram for indicating a bit allocation executed in registers of the channel control register 401. The channel control register 401 corresponds to such a register for controlling a data transfer operation of the DMA controller 207 every channel. A bit number “0” corresponds to a request enable bit “RE.” This request enable bit “RE” indicative of a valid/invalid state of a data transfer request signal which is connected to the instance capable unit 301. Symbol “1” implies a “valid” state, whereas symbol “0” implies an “invalid” state.

Both the bit number 1 and the bit number 2 correspond to a transfer data size bit TS[1:0] during a data transfer operation. Based upon a value indicated by the transfer data size bit TS[1:0], the below-mentioned data sizes for the DMA transfer operation are selected:

When the transfer data size bit is “0”, - - - “byte”;

when the transfer data size bit is “1”, - - - , “word”; and

when the transfer data size bit is “2”, - - - , “long word.”

The bit number 3 corresponds to such a transfer mode bit TM for indicating as to whether a transfer mode of a DMA transfer operation is a cycle steal transfer operation, or a burst transfer operation. Symbol “1” implies the burst transfer operation, and symbol “0” implies the cycle steal transfer operation.

A cycle steal transfer operation corresponds to such a transfer mode that every time a data transfer operation of the DMA controller is carried out, a bus right is opened to the CPU 200. A burst transfer operation corresponds to such a transfer mode that while data are transferred plural times equal to a total transfer time which is set into the transfer time register 402, a bus right is not opened to the CPU 200.

A bit number 4 to a bit number (4+L) correspond to resource select bits RS[L:0] used to select data transfer request signals which are accepted as requests. Based upon a value indicated by this resource select bit RS[L:0], a data transfer request signal is selected as follows:

When the resource select bit is equal to “0”, - - - data transfer request signal of an external device;

when the resource select bit is equal to “1”, - - - data transfer request signal of the peripheral device “0”;

when the resource select bit is equal to “2”, - - - data transfer request signal of the peripheral device “1”; - - -

when the resource select bit is equal to “M+1”, - - - , data transfer request signal of the peripheral device “M.”

The bit width (L+1) of the resource select bit RS[L:0] may be expressed by the below-mentioned formula (1) in accordance with a peripheral device number:

L+1=INT (log2 (M+2)) (1).

It should be noted that symbol “INT” indicates an integer operator.

As indicated in FIG. 4, data is written from a data bus signal pd[31:0] (357) of the peripheral bus into the channel control register 401. An output port of an AND gate 406 is connected to an enable signal(470) of the channel control register 401. The AND gate 406 inputs thereinto a channel select signal ppchsel(461) and a channel control register select signal ppchcrsel(752). The channel select signal ppchsel(461) indicates that the data on the data bus signal pd[31:0] (357) corresponds to such data with respect to which channel. The channel control register select signal ppchcrsel(752) indicates that this data corresponds to such data with respect to the channel control register 401.

Any one of bits of a channel select signal ppchsel[Z:0] outputted from the channel number depending unit 300 is connected to the channel select signal ppchsel(461) of the instance capable unit 301. For example, in the case that the instance capable unit 301 corresponds to the channel “0”, the channel select signal ppchsel[0] is connected. When the instance capable unit 301 corresponds to the channel “Z”, the channel select signal ppchsel[Z] is connected.

The transfer number register 402 corresponds to a register to which a data transfer number of the DMA controller 207 is set. This transfer number register 402 is decremented every time data is written into a transfer destination. There are two cases; namely, the data is written from the data bus signal pd[31:0] (357) into the transfer time register 402, and also the data is written from a decrementer output signal tcrnext[31:0] (1850) of the channel number not-depending unit 302 into the transfer time register 402.

An output port of an OR gate 409 is connected to the enable signal(471) of the transfer time register 402. Both an output signal of an AND gate 408 and an output signal of an AND gate 407 are connected to an input prt of the OR gate 409. Both a transfer time register select signal pptcrsel(755) and a channel select signal ppchsel(461) are connected to an input port of the AND gate 408. This transfer time register select signal pptcrsel(755) indicates that the data on the data bus signal pd[31:0] (357) is equal to such data with respect to the transfer time register 402.

Both a channel select signal dmachsel(462) and a transfer time register updating instruction signal dmawtcr(1852) are connected to the input port of the AND gate 407. The channel select signal dmachsel (462) indicates that which channel is selected during the DMA transfer operation. The transfer time register updating instruction signal dmawtcr(1852) instructs to update the transfer time register 402 during the DMA transfer operation.

An output signal of a selector 416 is connected to the transfer time register 402. The selector 416 selects the decrementer output signal tcrnext[31:] (1850) when the transfer time register updating instruction signal dmawtcr(1852) is equal to “1”, and selects the data bus signal pd[31:0] (357) when the transfer time register updating instruction signal dmawtcr(1852) is equal to “0”, and then outputs the selected signals to the transfer time register 402.

Any one of bits of a channel select signal dmachsel[Z:0] (751) outputted from the channel number depending unit 300 is connected to the channel select signal dmachsel(462) of the instance capable unit 301. For example, in the case that the instance capable unit 301 corresponds to the channel “0”, the channel select signal dmachsel[0] is connected. When the instance capable unit 301 corresponds to the channel “Z”, the channel select signal dmachsel[Z] is connected.

A source address register 403 corresponds to such a register for setting a transfer source address during the data transfer operation of the DMA controller 207. Every time the DMA controller 207 reads data of a transfer source, a transfer data size is added to the source address register 403.

There are two cases when a transfer source address is written into the source address register 403, namely, a transfer source address is written from a data bus signal pd[31:0] (357), and also a transfer source address is written from an address adder output signal adrnext[31:0] (1851) of the channel number not-depending unit 302. An output port of the OR gate 412 is connected to an enable signal (472) of the source address register 403. Both the output signal of the AND gate 411 and the output signal of the AND gate 410 are connected to the input port of the OR gate 412.

Both a source address register select signal ppsarsel(753) and also a channel select signal ppchsel(461) are connected to the input port of the AND gate 411. This source address register select signal ppsarsel(753) indicates that the data on the data bus signal pd[31:0] (357) corresponds to such data with respect to the source address register 403.

Both a channel select signal dmachsel(462) and a source address register updating instruction signal dmawsar(1853) are connected to the input port of the AND gate 410. This source address register updating instruction signal dmawsar(1853) instructs to update the source address register 403 during the DMA transfer operation.

An output signal of a selector 417 is connected to the source address register 403. The selector 417 selects the address adder output signal adrnext[31:0] (1851) when the source address register updating instruction signal dmawsar(1853) is equal to “1”, and selects the data bus signal pd[31:0] (357) when the source address register updating instruction signal dmawsar(1853) is equal to “0”, and then outputs the selected signal to the source address register 403.

A destination address register 404 corresponds to such a register used to set a transfer destination address during the data transfer operation of the DMA controller 207. A transfer data size is added to this destination address register 404 every time the DMA controller 207 writes data into a transfer destination. The transfer data size is written into the destination address register 404 in the two cases; namely, the transfer data size is written from the data bus signal pd[31:0] (357), and also from the address adder output signal adrnext[31:0] (1851) of the channel number not-depending unit 302.

An output port of an OR gate 415 is connected to an enable signal(473) of the destination address register 404. Both the output signal of the AND gate 414 and the output signal of the AND gate 413 are connected to an input port of the OR gate 415.

Both a destination address register select signal ppdarsel(754) and a channel select signal ppchsel(461) are connected to an input port of the AND gate 414. This destination address register select signal ppdarsel(754) indicates that the data on the data bus signal pd[31:0] (357) corresponds to such data with respect to the destination address register 404.

Both the channel select signal dmachsel(462) and a destination address register updating instruction signal dmawdar(1854) are connected to the input port of the AND gate 413. This destination address register updating instruction signal dmawdar(1854) instructs to update the destination address register 404 during the DMA transfer operation.

An output signal of a selector 418 is connected to the destination address register 404. The selector 418 selects the address adder output signal adrnext[31:0] (1851) when the destination address register updating instruction signal dmawdar(1854) is equal to “1”, and selects the data bus signal pd[31:0] (357) when the destination address register updating instruction signal dmawdar(1854) is equal to “0”, and then outputs the selected signal to the destination address register 404.

FIG. 6 is a diagram for indicating an example of an HDL program of a request selector circuit 400 in the case that a total number (=M+1) of the peripheral devices is equal to 7. The request selector circuit 400 corresponds to such a circuit for selecting a data transfer request inputted into the instance capable unit 301 in response to a value of the resource select bit RS[L:0] of the channel control register 401.

An one of the data transfer request signals ed_req[0] through ed_req[3] of the external device 100 is connected to an input port ed_req of FIG. 6. For instance, in the case of the channel “0”, the data transfer request signal ed_req[0] is connected to this input port. In the case of the channel “3”, the data transfer request signal ed_req[3] is connected to this input port. The data transfer requests pd_req[6:0] of all of the peripheral devices 101 are connected to the input port pd_req. A resource select bit RS[2:0] of the channel control register 401 is connected to an input port rs.

Based upon values (3′h0 to 3′h7) of the input port rs, any one of the data transfer request signals ed_req, pd_req[0] to pd_req[6] is selected to be outputted to an output port rreq.

Both an output signal rreq(479) of the request selector circuit 400 and a request enable bit RE of the channel control register 401 are entered into the AND gate 405 of the instance capable unit 301.

As a consequence, an output signal sreq(450) of the AND gate 405 is asserted only when the request enable bit RE is set to “1.”

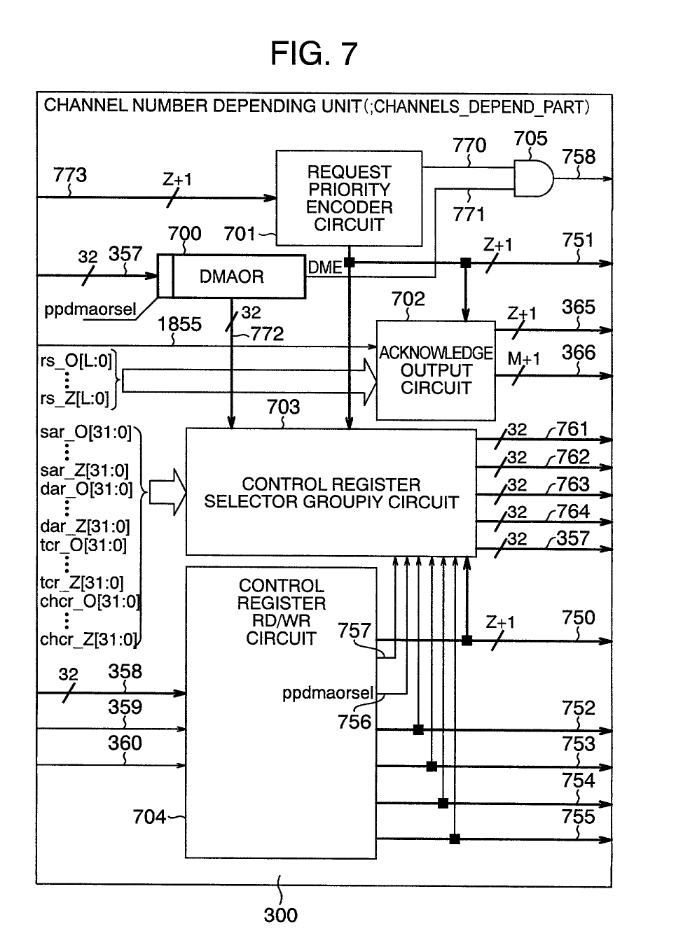

FIG. 7 to FIG. 18 are diagrams related to the channel number depending unit 300.

FIG. 7 is a schematic block diagram for representing an internal arrangement of the channel number depending unit 300. The channel number depending unit 300 is arranged by a DMA operation register 700, a request priority encoder circuit 701, an acknowledge output circuit 702, a control register selector grouping circuit 703, and a control register RD/WR circuit 704.

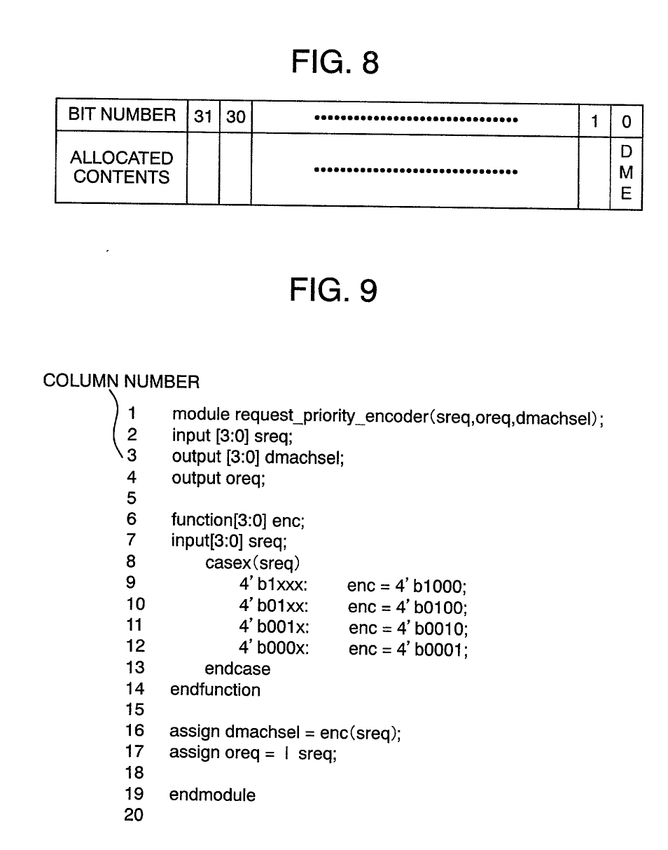

FIG. 8 is a diagram for representing a bit allocation executed in registers of the DMA operation register 700. The DMA operation register 700 corresponds to a control register related to the entire arrangement of the DMA controller 207. This DMA operation register 700 is arranged by such a flip-flop equipped with an enable having a 32-bit bit-width. A bit number “0”corresponds to a DMA request enable bit “DME” indicative of valid/invalid states of all of the data transfer request signals.

FIG. 9 is a diagram for representing an example (MSB priority) of an HDL program of a request priority encoder circuit 701 in the case that a total number (=z+1) of the external devices is equal to 4. The request priority encoder circuit 701 corresponds to such a circuit for selecting a request of a data transfer operation outputted from the instance capable unit 301 of each channel.

An output signal sreq of the instance capable unit 301 of each channel is connected to an input port sreq of FIG. 9. For instance, an output signal sreq of an instance capable unit 301 of a channel “0” is connected to an input port sreq[0], and an output signal sreq of an instance capable unit 301 of a channel 3 is connected to an input port sreq[3]. A bit number of an output port dmachsel[3:0] corresponds to a channel number, and it is so assumed that a channel is selected when a bit is equal to “1.”

A channel to be selected is determined based upon a value of an input port sreq[3:0]. For example, in the case that the input port sreq[0] is equal to “1”, it is so assumed that the output port dmachsel[0] is set to “1” so as to select the channel “0.” In the case that the input port sreq[3] is equal to “1”, it is so assumed that the output port dmachsel[3] is set to “1” so as to select the channel “3.”

Also, in such a case that plural bits among the input ports sreq[0] through sreq[3] are equal to “1” at the same time, the channels are selected in accordance with the priority orders in this order of: channel 3>channel 2>channel 1>channel 0. OR of the input ports sreq[0] to sreq[3] are outputted to an output port oreq.

Both an output signal oreq(770) of the request priority encoder circuit 701 and a DMA request enable bit DME of an operation register 700 are inputted to the AND gate 705 of the channel number depending unit 300.

As a consequence, an output signal csreq(758) of the AND gate 705 is assented only when “1” is set to the DMA request enable bit DME.

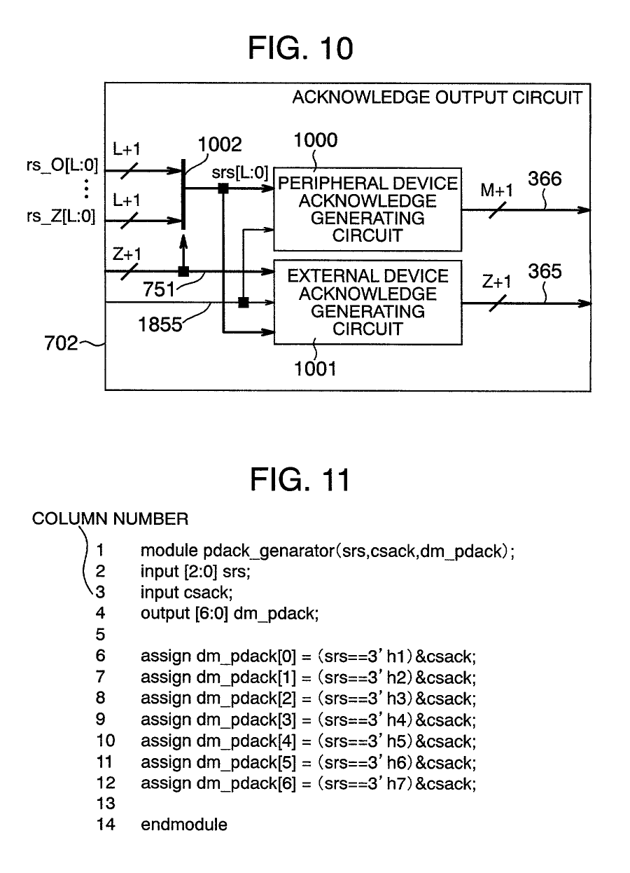

FIG. 10 is a schematic block diagram for representing an internal arrangement of the acknowledge output circuit 702. This acknowledge output circuit 702 is arranged by a peripheral device acknowledge generating circuit 1000, an external device acknowledge generating circuit 1001, and a selector circuit 1002.

The selector circuit 1002 is connected to a resource select bit signal rs[L:0] (451) outputted from the instance capable unit 301 of each channel.

When the resource select bit signal rs[L:0] (451) of each channel is connected to the channel number depending unit 300, this resource select bit signal rs[L:0] (451) is converted into such a signal name to which a suffice of a channel number is added, and then, the resulting signal is connected to this channel number depending unit 300.

For instance, a resource select bit signal rs[L:0] of a channel number “0” is connected to the channel number depending unit 300 in the signal name of rs_0[L:0]. The selector circuit 1002 corresponds to a circuit for selecting resource select bit signals “rs_0” to “rs_Z” of the respective channels in response to the channel select signal dmachsel[Z:0] (751). The selected resource select bit signal srs[L:0] is outputted to both the peripheral device acknowledge generating circuit 1000 and the external device acknowledge generating circuit 1001.

FIG. 11 is a diagram for indicating an example of an HDL program of the peripheral device acknowledge generating circuit 1000 in such a case that a total number (=M+1) of the peripheral devices is equal to 7. The peripheral device acknowledge generating circuit 1000 corresponds to a circuit for asserting an acknowledge signal to such a peripheral device which requests to transfer data.

The peripheral device acknowledge generating circuit 1000 outputs a base signal csack(1855) of acknowledgement outputted by the channel number not-depending unit 302 to any one of data transfer acknowledge signals (dm_pdack[0] through dm_pdack[6]) of the peripheral devices in response to the resource select bit signal srs[2:0].

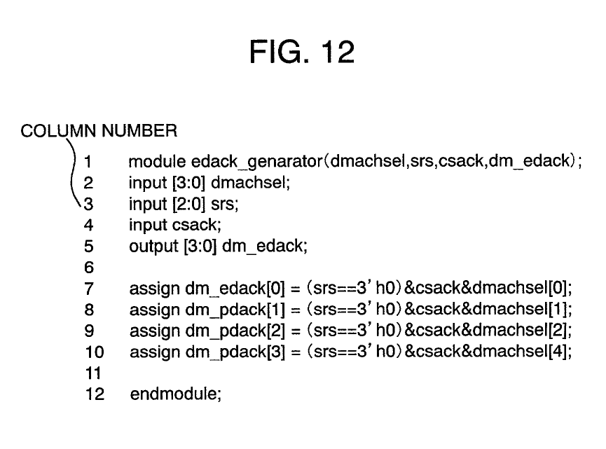

FIG. 12 is a diagram for indicating an example of an HDL program of the peripheral device acknowledge generating circuit 1001 in such a case that a total number (=Z+1) of the peripheral devices is equal to 4. The peripheral device acknowledge generating circuit 1001 corresponds to a circuit for asserting an acknowledge signal to such a peripheral device which requests to transfer data.

The external device acknowledge generating circuit 1001 outputs the base signal csack(1855) of acknowledgement outputted by the channel number not-depending unit 302 to any one of data transfer acknowledge signals (dm_edack[0] through dm_edack[3]) of the external devices in response to the channel number select signal dmachsel[3:0].

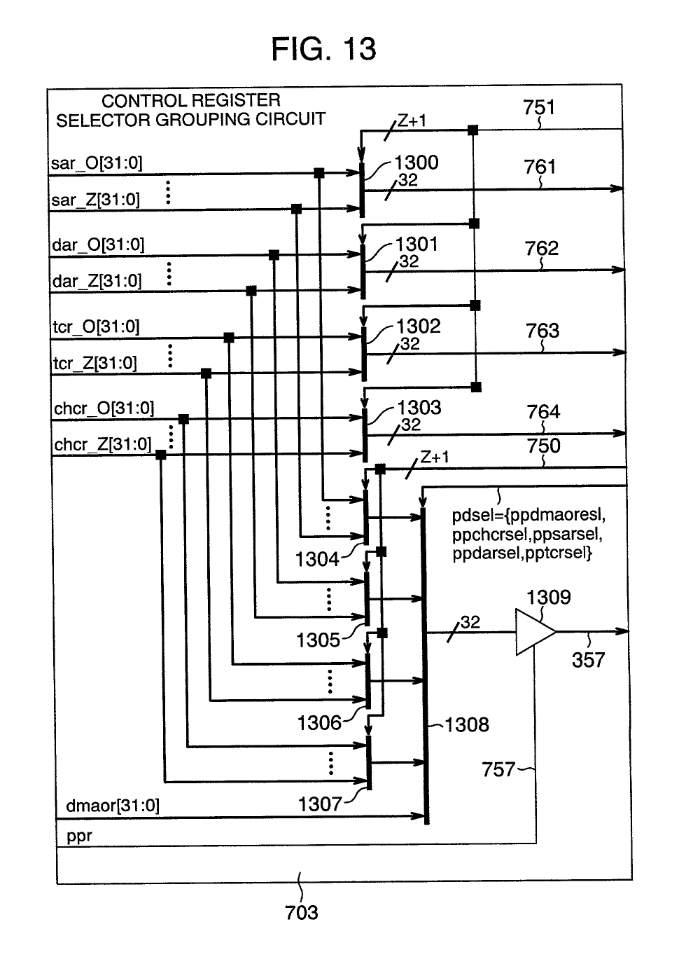

FIG. 13 is a schematic block diagram for indicating an internal arrangement of the control register selector grouping circuit 703. The control register selector grouping circuit 703 corresponds to such a circuit operated in such a manner that the output data of the respective control registers is selected based upon a channel number of a channel used to perform a DMA transfer operation, and when the CPU 200 reads out the data of the respective control registers of the DMA controller 207, data of the designated control register is selected.

A channel control register output signal chcr[31:0] (452) outputted by the instance capable unit 301 of each channel, a source address register output signal sar[31:0] (454), a destination address register output signal dar[31:0] (455), and an output signal of a control register of a transfer time register output signal tcr[31:0] (453) are connected to the control register selector grouping circuit 703.

When the output signals of these control registers of the respective channels are connected to the channel number depending unit 300, these control registers are connected thereto in the signal names to which suffices of the channel numbers are added. For example, a channel control register output signal chcr[31:0] of a channel number “0” is connected to the channel number depending unit 300 in the signal name of chcr_0[31:0].

As the control register selector grouping circuit 703, there are provided: a selector 1300 for selecting source address registers (sar_0 to sar_Z) of the respective channels; another selector 1301 for selecting destination address registers (dar_0 to dar_Z); another selector 1302 for selecting transfer number register(tcr_0 to tcr_Z); and another selector 1303 for selecting channel control registers (chcr_0 to chcr_Z) in response to the channel select signal dmachsel[Z:0] (751).

From these selectors, output signals (761 to 764) of control registers of such a channel are outputted, and this channel is selected during the DMA transfer operation.

Also, as the selector for selecting the output in response to the channel selection signal ppchsel[Z:0] (750), there are provided: a selector 1304 for selecting the source address registers (sar_0 to sar_Z) of the respective channels; another selector 1305 for selecting the destination address registers (dar 0 to dar Z); another selector 1306 for selecting the transfer number registers (tcr 0 to tcr Z); and another selector 1307 for selecting the channel control registers (chcr_0 to chcr_Z).

Furthermore, there is such a selector 1308 for selecting any one of the above-described output signals of these selectors, and the DMA operation register output signal (772) to be outputted to the data bus signal pd[31:0] (357). An output of the selector 1308 is outputted via a tri-state buffer 1309 to the data bus signal pd[31:0] (357).

A select signal pdsel of the selector 1308 is constituted by a source address register select signal ppsarsel(753), a destination address register select signal ppdarsel(754), a transfer number register select signal pptcrsel(755), a channel control register select signal ppchcrsel(752), and a DMA operation register select signal ppdmaorsel(756).

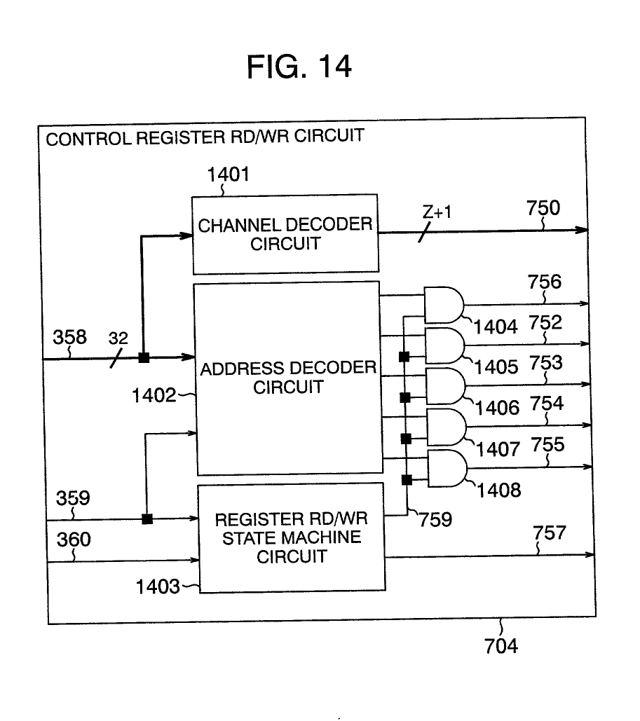

FIG. 14 is a schematic block diagram-for showing an internal arrangement of the control register RD/WR circuit 704. This control register RD/WR circuit 704 is constructed of an address decoder circuit 1402, a channel decoder circuit 1401, a register RD/WR state machine circuit 1403, and several sets of AND gates (1404 to 1408).

FIG. 15 is a diagram for representing an example of an address map related to control registers in the case that a total number (=Z+1) of the channels is equal to 4.

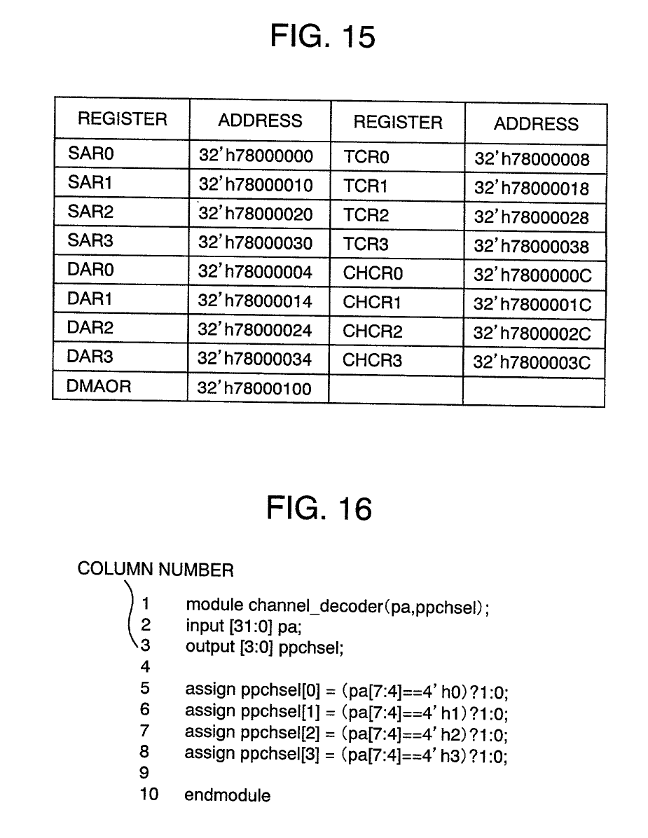

FIG. 16 is a diagram for indicating an HDL program of the channel decoder circuit 1401. The channel decoder circuit 1401 corresponds to such a circuit operated in such a manner that when the CPU 200 accesses the respective control registers employed in the DMA controller 207, this channel decoder circuit 1401 decodes an address map of FIG. 15, and then, controls such a select signal indicative of a channel number of a control register.

The channel decoder circuit 1401 judges as to whether or not an address of an address bus signal pa[31:0] (358) corresponds to an address of which channel number based upon values of bit numbers 4 to 7 of this address bus signal, and then, asserts a bit of the relevant channel signal ppchsel[Z:0] (750). For instance, in the case that the values of the bit numbers 4 to 7 of the address bus signal pa[31:0] (358) are equal to 4′h0, the channel decoder circuit 1401 asserts the channel select signal ppchcel[0], whereas in the case that the values of the bit numbers 4 to 7 thereof are equal to 4′h3, the channel decoder circuit 1401 asserts the channel select signal ppchsel[3].

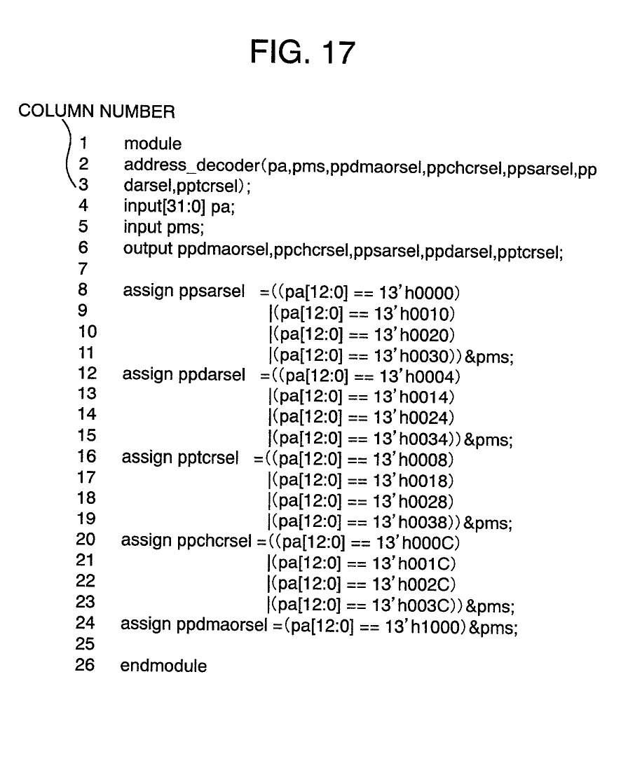

FIG. 17 is a diagram for indicating an HDL program of the address decoder circuit 1402. The address decoder circuit 1402 corresponds to such a circuit operated in such a manner that when the CPU 200 accesses the respective control registers employed in the DMA controller 207, this address decoder circuit 1401 decodes the address map of FIG. 15, and then, controls such a select signal indicative of a sort of a control register.

The address decoder circuit 1402 judges as to whether or not the address of the address bus signal pa[31:0] (358) corresponds to an address of which channel number based upon a value of a lower-grade 13 bit of this address bus signal pa[31:0] (358), and then, asserts a register select signal of the relevant control register. For example, in the case that the value of the lower-grade 13 bit of the address bus signal pa[31:0] (358) is equal to 13′h0000, the address decoder circuit 1402 asserts a source address register select signal ppsarsel(753). Also, in the case that the value of the lower-grade 13 bit of the address bus signal pa[31:0] (358) is equal to 13′h0030, the address decoder circuit 1402 asserts a channel control register select signal ppchcrsel(752).

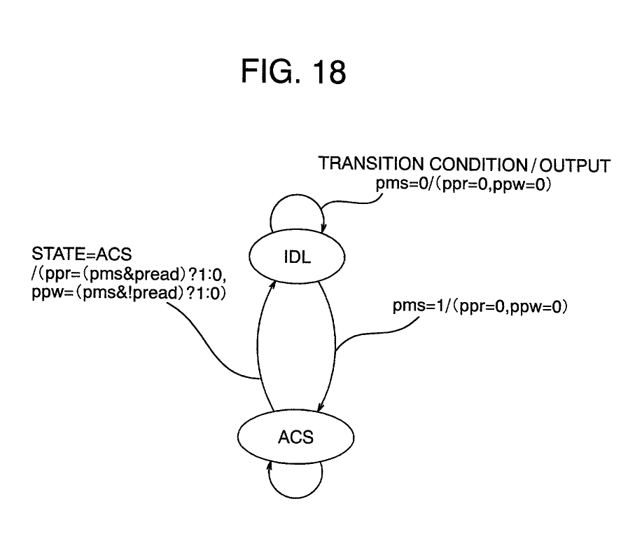

FIG. 18 is a state transition diagram for indicating the register RD/WR state machine circuit 1403 by way of a Mealy type description. This register RD-WR state machine circuit 1403 corresponds to such a circuit for controlling a strobe signal used to a read/write operation with respect to a control register when the CPU 200 accesses the control register.

An initial state of the register RD/WR state machine circuit 1403 just after a chip reset corresponds to an IDL state. If a module select signal pms(359) is a negate, then the register RD/WR state machine circuit 1403 remains at the IDL state. When the module select signal pms(359) is asserted, the register RD/WR state machine circuit 1403 is advanced to an ACS state.

In the case that under the ACS state, the module select signal pms(359) is equal to 1 and the strobe signal pread(360) is equal to 1, the register RD/WR state machine circuit 1403 asserts a read strobe signal ppr(757). When the module select signal pms(359) is equal to 1 and the strobe signal pread(360) is equal to 0 under the ACS state, this register RD/WR state machine circuit 1403 asserts a write strobe signal ppw(759), and is advanced to the IDL state.

In order that the register select signals (752 to 756) of the respective control registers, which are outputted by the address decoder circuit 1402, are asserted only during the writing operation, these register select signals are AND-gated with the write strobe signal ppw(759) by the AND gates (1404 to 1408).

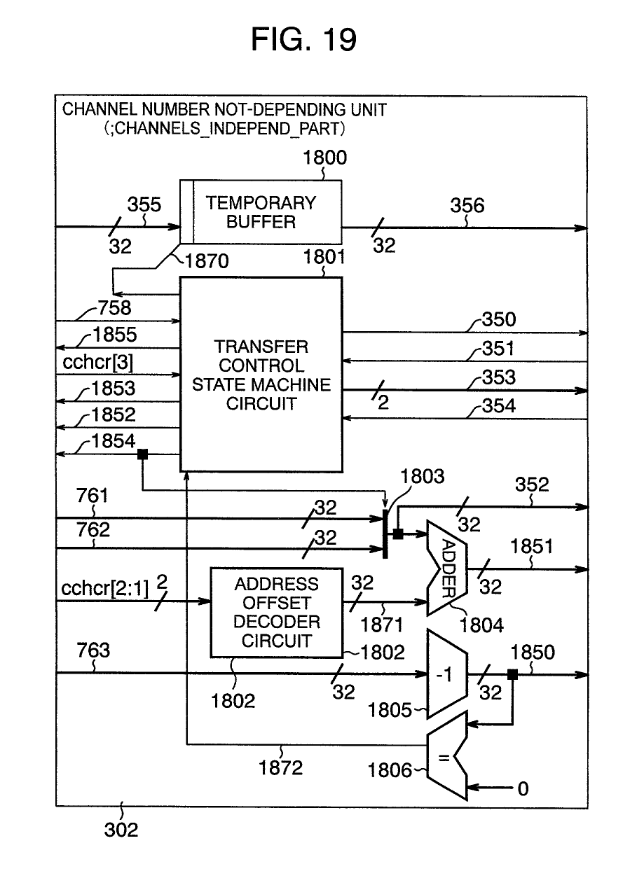

FIG. 19 is a schematic block diagram for representing an internal arrangement of the channel number not-depending unit 302. The channel number not-depending unit 302 is arranged by a temporary buffer 1800, a transfer control state machine circuit 1801, an address offset decoder circuit 1802, a selector 1803, an adder 1804, a decrementer 1805, and also a comparator 1806. The channel number not-depending unit 302 is arranged by such a circuit which does not depend on a total channel number.

The temporary buffer 1800 corresponds to such a register which temporarily stores thereinto data read from a transfer source during a DMA transfer operation, and supplies the stored data to the BSC 206. The temporary buffer 1800 stores thereinto such data which is transmitted by the BSC 206 via a reading data signal ib_dmd(355). The temporary buffer 1800 updates data in response to asserting of an enable signal dmd_e(1870) which is outputted by the transfer control state machine circuit 1801. The transfer control state machine circuit 1801 corresponds to such a circuit for controlling various sorts of control lines related to the data transfer of the DMA controller 207.

As indicated in FIG. 19, the transfer control state machine circuit 1801 outputs a bus right request signal dm_busreq(350) with respect to the BSC 206, and inputs thereinto a bus right acknowledge signal ib_dmbusack(351) corresponding to a response signal thereof.

The transfer control state machine circuit 1801 outputs a data transfer command signal dm_cmd[1:0] (353) used to send a read/write command with respect to the BSC 206, and inputs thereinto a transfer command acknowledge signal ib_dmbusrdy(354) corresponding to a response signal thereof.

Also, the transfer control state machine circuit 1801 inputs thereinto an output signal csreq(758) of the AND gate 705 of the channel number depending circuit 300, and outputs an acknowledge base signal csack(1855) corresponding to a response signal thereof.

Furthermore, this transfer control state machine circuit 1801 inputs thereinto a transfer mode bit signal TM(=cchcr[3]) of a channel control register signal cchcr[31:0] (764) which is outputted from the channel number depending unit 300, and also outputs a source address register updating instruction signal dmawsar(1853), a destination address register updating instruction signal dmawdar(1854), a transfer time register updating instruction signal dmawtcr(1852), and an enable signal dmd_e(1870) of the temporary buffer 1800. The source address register updating instruction signal dmawsar(1853) is used to instruct updating of the source address register 403 when the DMA transfer operation is carried out. The destination address register updating instruction signal dmawdar(1854) is used to instruct updating of the destination address register 404. The transfer time register updating instruction signal dmawtcr(1852) is used to instruct updating of the transfer time register 402.

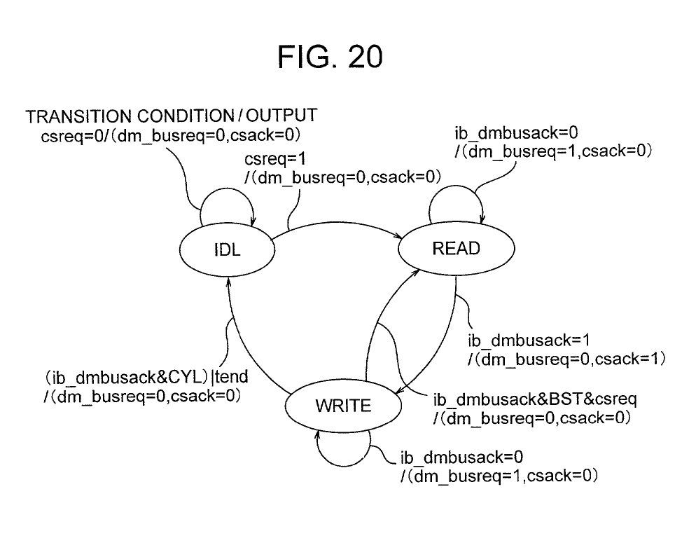

FIG. 20 is a state transition diagram for indicating a main sequence of the transfer control state machine circuit 1801. States occurred in the data transfer main sequence of the DMA controller 207 is constructed of an IDL state, a READ state, and a WRITE state. The IDL state is to continuously waits that the output signal csreq of the AND gate 705 is asserted. The READ state causes the BSC 206 to issue a read command. The WRITE state causes the BSC 206 to issue a write command.

An initial state of the transfer control state machine circuit 1801 immediately after the chip reset corresponds to the IDL state. When the output signal csreq of the AND gate 705 is a negate, the transfer control state machine circuit 1801 remains under the IDL state. When the output signal csreq of the AND gate 705 is asserted, the transfer control state machine circuit 1801 is advanced to the READ state.

In the READ state, a bus right request signal dm_busreq(350) is asserted with respect to the BSC 206 in order to read data of a transfer source address, and the transfer control state machine circuit 1801 continuously waits that a bus right acknowledge signal ib_dmbusack(351) corresponding to a response signal of this bus right request signal is asserted by the BSC 206. When the bus right acknowledge signal ib_dubusack (351) is asserted, the transfer control state machine circuit 1801 is advanced to the WRITE state.

In the WRITE state, the bus right request signal dm_busreq(35) is again asserted with respect to the BSC 206 in order to write data to a transfer destination address, and the transfer control state machine circuit 1801 continuously waits that the bus right acknowledge signal ib_dmbusack(351) corresponding to the response signal thereof is asserted by the BSC 206. In the case that while the bus right acknowledge signal ib_dumbusack(351) is asserted, the transfer mode bit signal TM is under the cycle steal (CYL), or a transfer end interrupt signal tend(1872) is asserted, the transfer control state machine circuit 1801 is advanced to the IDL state.

In the WRITE state, in such a case that while the bus right acknowledge signal ib_dmbusack(351) is asserted, the transfer mode bit signal TM is under the burst (BST), the transfer control state machine circuit 1801 is advanced to the READ state.

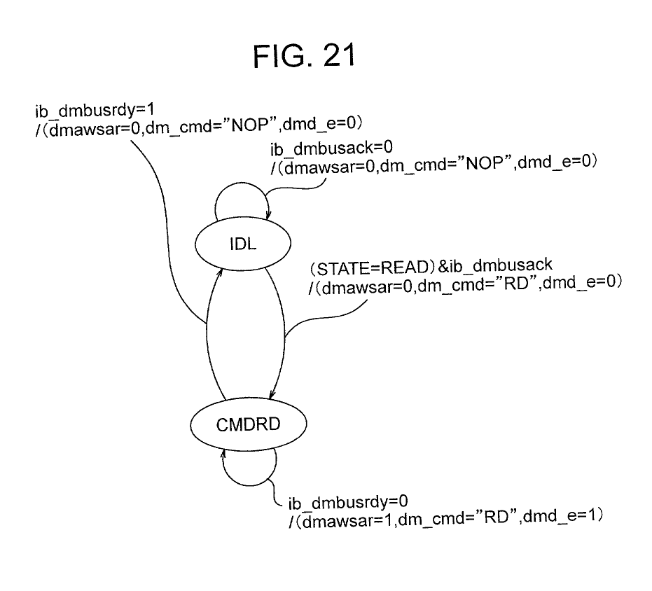

FIG. 21 is a state transition diagram in which a read command issuing sequence is represented by way of the Mealy type description in the case that the present state of the DMA controller 207 is advanced to the READ state. An initial condition just after a chip reset in the read command issuing sequence corresponds to the IDL state.

When the bus right acknowledge signal ib_dmbusack(351) sent from the BSC 206 is a negate, the DMA controller 207 remains under the IDL state. When this bus right acknowledge signal ib_dmbusack(351) is asserted, the DMA controller 207 sets a keyword “RD” of a read command to a data transfer command signal dm cmd[1:0] (353), and issues the set data transfer command signal to the BSC 206, and then, is advanced to a read command issue state CMDRD.

In this CMDRD state, the DMA controller 207 continuously waits that a transfer command acknowledge signal ib_dmbusrdy(354) with respect to the read command of the data transfer command signal dm_cmd[1:0] (353) is asserted, and asserts a source address register updating instruct signal dmawsar(1853) so as to update the source address register 403. Also, this DMA controller 207 asserts an enable signal dmd_e(1870) in order to write data of a reading data signal ib_dmd[31:0] (355) into the temporary buffer 1800.

Upon receipt of the read command from the DMA controller 207, the BSC 206 reads data from a transfer source address indicated by a data transfer address signal dm_a[31:0] (352), and transmits the data of the transfer source address to the DMA controller 207 based upon a reading data signal ib_dmd[31:0] (355).

When a transfer command acknowledge signal ib_dmbusrdy(354) is asserted in the CMDRD state, the DMA controller 207 is advanced to the IDL state.

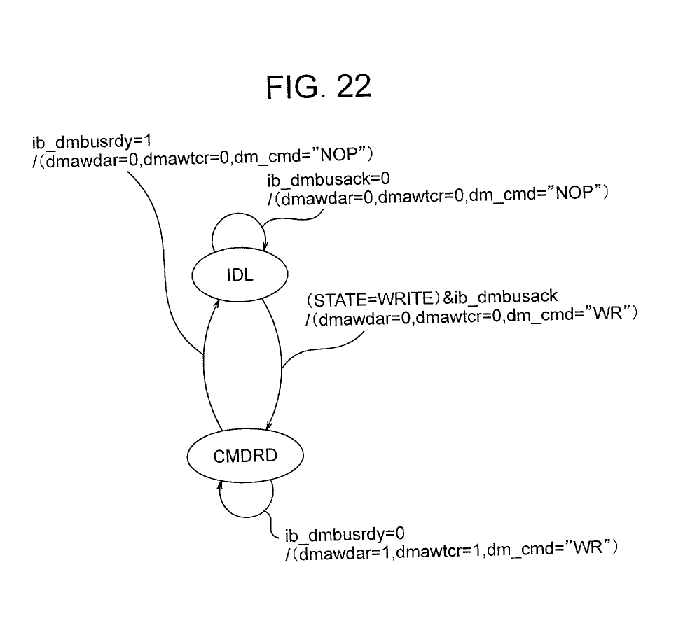

FIG. 22 is a state transition diagram in which a write command issuing sequence is represented by way of the Mealy type description in the case that the present state of the DMA controller 207 is advanced to the WRITE state. An initial condition just after a chip reset in the write command issuing sequence corresponds to the IDL state.

When the bus right acknowledge signal ib_dmbusack(351) sent from the BSC 206 is a negate, the DMA controller 207 remains under the IDL state. When this bus right acknowledge signal ib_dmbusack(351) is asserted, the DMA controller 207 sets a keyword “WR” of a write command to the data transfer command signal dm_cmd[1:0] (353), and issues the set data transfer command signal to the BSC 206, and then, is advanced to a write command issue state CMDWR.

In this CMDWR state, the DMA controller 207 continuously waits that the transfer command acknowledge signal ib_dmbusrdy(354) with respect to the write command of the data transfer command signal dm_cmd[1:0] (353) is asserted, and asserts both a destination address register updating instruction signal dmawdar (1854) in order to update the destination address register 404, and also a transfer time register updating instruction signal dmawtcr(1852) so as to update the transfer time register 402.

Upon receipt of the write command from the DMA controller 207, the BSC 206 reads data of the temporary buffer 1800 via a writing data signal dm_d[31:0] (356), and writes the data into such a transfer destination address indicated by a data transfer address signal dm a[31:0] (352).

When the transfer command acknowledge signal ib_dmbusrdy(354) is asserted in the CMDWR state, the DMA controller 207 is advanced to the IDL state.

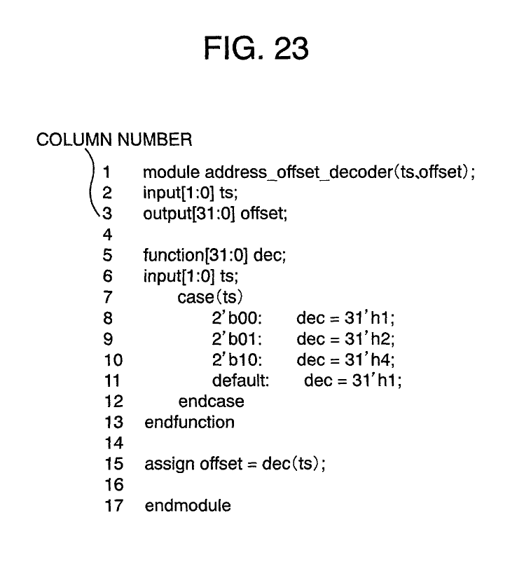

FIG. 23 is a diagram for showing an HDL program of the address offset decoder circuit 1802. The address offset decoder circuit 1802 corresponds to a circuit for decoding an address increase amount of either a transfer source or a transfer destination from a transfer data size bit TS[1:0].

A selector 1803 corresponds to such a circuit for selecting either an output signal csar[31:0] (761) or another output signa cdar[31:0] (762) of the channel number depending unit 300 in response to the destination address register updating instruction signal dmawdar(1854).

When the destination address register updating instruction signal dmawdar(1854) is equal to “0”, this selector 1803 selects the output signal csar[31:0] (761). When the destination register updating instruction signal dmawdar(1854) is equal to “1”, the selector 1803 selects the output signal cdar[31:0] (762). The selected resultant signal by the selector 1803 is set as an input signal to an adder 1804. This adder 1804 corresponds to such a circuit which adds the address increase amount outputted from the address offset decoder circuit 1802 to an address outputted from the selector 1803, and then outputs an address signal adrnext(1851) of the next data transfer operation.

A comparator 1850 corresponds to such a circuit which compares “0” with an output signal tcrnext(1850) of the decrementer 1805, and then asserts a transfer end interrupt signal tend(1872) in the case of “0.”

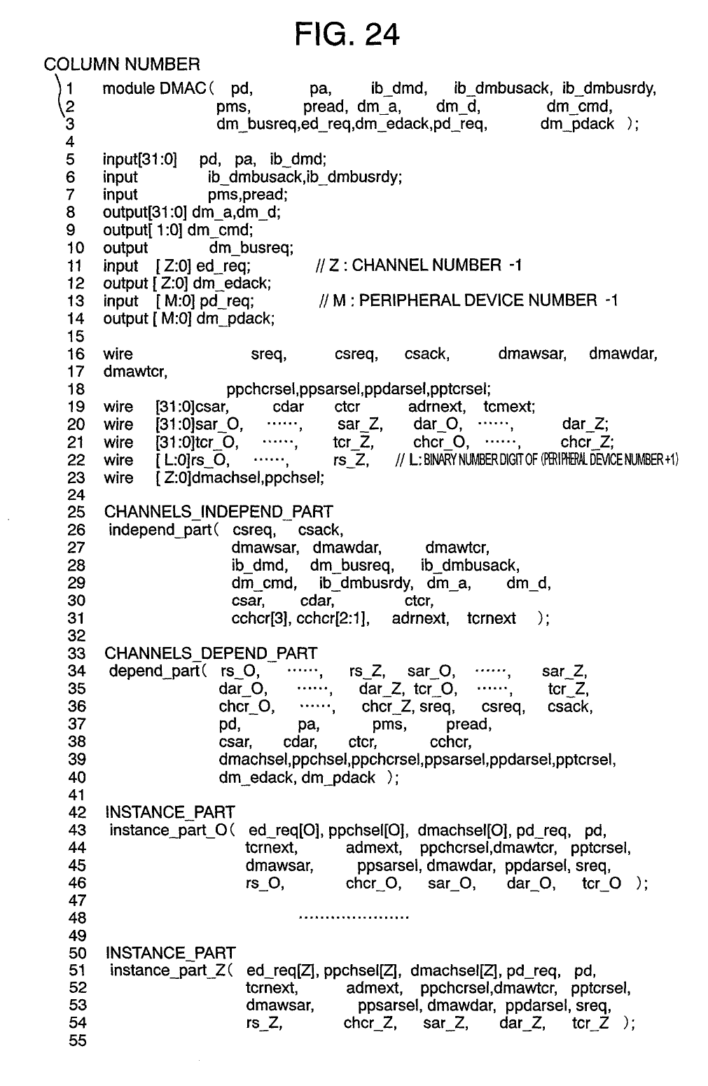

FIG. 24 is a diagram for indicating an example of an HDL program of a top hierarchy of the DMA controller 207. A first column to a third column correspond to a “module” statement. A fifth column to a 14-th column correspond to a port declaration. A 16-th column to a 21st column correspond to a net declaration. A 23rd column to a 52nd column correspond to an instance statement.

As indicated in the 11-th column, as to the port statement of the top hierarchy of the DMA controller 207, the data transfer request signal ed_req of the external device 100 is defined as an input signal of a bit-width of a channel number Z+1. Also, as indicated in the 13-th column, the data transfer request signal pd_req of the peripheral device 101 is defined as an input signal of a bit-width of a peripheral device number M+1. Furthermore, as shown in the 12th column and the 14th column, the acknowledge signal dm_edack with respect to the external device 100, and also the acknowledge signal dm_pdack with respect to the peripheral device 101 are defined as an output signal of a bit-width of a channel number Z+1, and an output signal of a bit-width of a peripheral device number M+1.

In the net declaration, as indicated in the 19-th column to the 20-th column, the following output signals outputted from the instance capable unit 301 of each channel are defined as internal signals (sar_0 to sar_Z, dar_0 to dar_Z, tcr_0 to tcr_Z, chcr_0 to chcr_Z) having 32-bit widths, namely, an output signal of a source address register, an output signal of a destination address register, an output signal of a transfer time register, and an output signal of a channel control register, respectively.

Also, as indicated in the 21st column, an output signal of a resource select bit outputted by the instance capable unit 301 of each channel is defined an internal signal (rs_0 to rs_Z) having a bit-width of L+1.

A channel select signal ppchsel and another channel select signal dmachsel are defined as internal signals having bit-widths of the channel number Z+1. The instance statement of the 24-th column corresponds to the channel number not-depending unit 302, and the instance statement of the 32nd column corresponds to the channel number depending unit 300. As indicated by the instance statement of the 32nd column of the channel number depending unit 300, the respective signals of the resource select bit, the source address register, the destination address register, the transfer time register, and the channel control register are connected to the channel number depending unit 300, the total number of which is equal to a total number of these channels.

The instance statements of the instance capable unit 301 are repeatedly described in the columns subsequent to the 41st column, the total number of which is equal to a total number of these channels. The 41st column corresponds to an instance statement of the instance capable unit 301 in the channel “0”, and the 49-th column corresponds to an instance statement of the instance capable unit 301 in the channel “Z.”As indicated by the instance statements of the instance capable unit 301 in the respective channels, the signal of the resource select bit of the relevant channel; the signal of the channel control register thereof; the signal of the source address register thereof; the signal of the destination address register thereof; and also the signal of the transfer time register thereof are connected to the instance capable unit 301 of each channel. Also, with respect to the data transfer request signal ed_req[Z:0] and the channel select signals ppchsel[Z:0] and dmachsel[Z:0] of the external device, only a bit of the relevant channel number is connected to the instance capable unit 301 of the relevant channel.

As represented in FIG. 24, in the case that the channel number Z+1 is changed, the port declarations of the 11-th column and the 12-th column are corrected; the net declarations of the 19-th column to the 20-th column are changed; and also the instance statement of the channel number depending unit 300 of the 32nd column is changed. The instance capable units 301 in the columns subsequent to the 41st column are repeatedly described plural times equal to a total number of these channels.

This DMA controller 207 executes the DMA transfer operation by employing the above-explained respective circuits in accordance with a series of the following operations.

First, before the DMA controller 207 executes the DMA transfer operation, the CPU 200 sets data to the respective registers. To make the DMA transfer operation valid, the DMA request enable bit DME of the DMA operation register 700 is set to “1.” Also, with respect to the channel control register 401 having the channel number, to which either the external device 100 or the peripheral device 101 where the DMA transfer operation is wanted to be executed is connected, the resource select bit RS[L:0], the transfer mode bit TM, and the transfer data bit size TS[1:0] are set. Also, the request enable bit RE is set to “1.” Furthermore, the transfer source address of the DMA transfer operation is set to the source address register 403, and the transfer destination address is set to the destination address register 404. When the data transfer request signal set by the resource select bit RS[1:0] is asserted by either the external device 100 or the peripheral device 101, the state of the transfer control state machine circuit 1801 is advanced from the IDL state to the READ state, and thus, the data transfer operation of the DMA transfer operation is commenced.

The DMA controller 207 transfers the transfer source address via the data transfer address signal dm_a[31:0] (352) to the BSC 206, accepts the data of this transfer source address via the reading data signal ib_dmd[31:0] (355) from the BSC 206, and then, saves the accepted data in the temporary buffer 1800.

When the DMA controller 207 transfers the transfer destination address via the data transfer address signal dm_a[31:0] (352) to the BSC 206, this BSC 206 writes the data of the temporary buffer 1800 at the transfer destination address. When the data is written at the transfer destination address, the DMA controller 207 updates the present address of the source address register 403 and the present address of the destination address register 404 by next addresses, and also decrements the transfer time register 402.

A series of such operations that the data is read out from the transfer source address and then the data is written at the transfer destination address is repeatedly carried out until the transfer time register 402 becomes “0”, and also the transfer end interrupt signal tend(1872) is asserted.

As previously described, the DMA controller 207 according to this embodiment mode 1 is arranged by such three sorts of functional blocks, namely, the channel number not-depending unit 302, the instance capable unit 301, and the channel number depending unit 300. This channel number not-depending unit 302 is constituted by the circuits which do not depend upon the channel number. The instance capable unit 301 is constituted by the circuits which do not depend upon the channel number, but is repeatedly used plural times equal to a total number of these channels. The channel number depending unit 300 contains the circuits which depend upon the channel number. As a consequence, even in such a case that a total number of these channels is increased/decreased by changing a total number of the external devices, only the HDL programs of the top hierarchies of both the channel number depending unit 300 and the DMA controller 207 may be merely corrected.

Also, since the circuit which depends upon the channel number is clearly separated from the circuit which does not depend upon the channel number, the logic file (namely, HDL program file) of the DMA controller whose channel number is changed may be automatically and readily generated.

In order that the logic file of the DMA controller is automatically generated, as to plural sorts of channel numbers, the logic files of the respective circuits of the channel number depending unit 300 are previously formed in either the automatic work manner or the manual work manner. While these logic files are prepared, both the channel number depending unit 300 of the designated channel number and the logic file of the top hierarchy may be coupled to the instance capable unit 301 and the logic file of the channel number not-depending unit 302.

With respect to the function blocks of the channel number depending unit 300, the instance capable unit 301, and the channel number not-depending unit 302, even when the logic hierarchies of these functional blocks are not necessarily prepared, such a logic file of the DMA controller whose channel number is changed may be generated.

However, even in such a case, with respect to the respective circuits contained in the channel number depending unit 300, the logic files should be automatically, or manually prepared every sort of the channel number.

Embodiment Mode 2

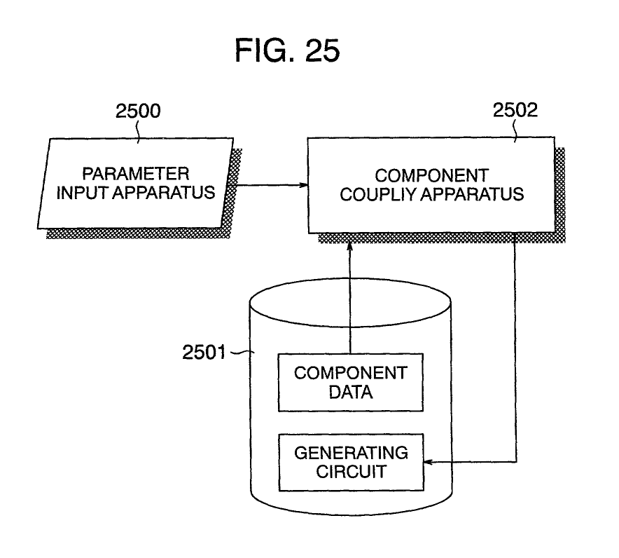

Referring now to FIG. 25 to FIG. 27, a description will be made of an arrangement and operation of an automatic DMA controller generating apparatus of an embodiment mode 2, equipped with such a means capable of automatically changing a total number of external devices and also a total number of peripheral devices, employed in a DMA controller so as to achieve the above-described second object of the present invention.

FIG. 25 is a schematic block diagram for indicating a system arrangement of the automatic DMA controller generating apparatus according to this embodiment mode 2. This automatic DMA controller generating apparatus may be realized in the process system equipped with a memory and a CPU such as a workstation and a personal computer.

This automatic DMA controller generating apparatus is constituted by a parameter input apparatus 2500, a file storage apparatus 2501, and a component coupling apparatus 2502. The parameter input apparatus 2500 is equipped with such a user interface. This user interface is used to input either a total number of external devices or a total number of channel numbers of a DAM controller which is wanted to be automatically generated. The file storage apparatus 2501 is provided with such a storage medium as a magnetic disk and a semiconductor memory. The component coupling apparatus 2502 couples the respective logic files of component data to each other so as to generate a logic file of the DMA controller.

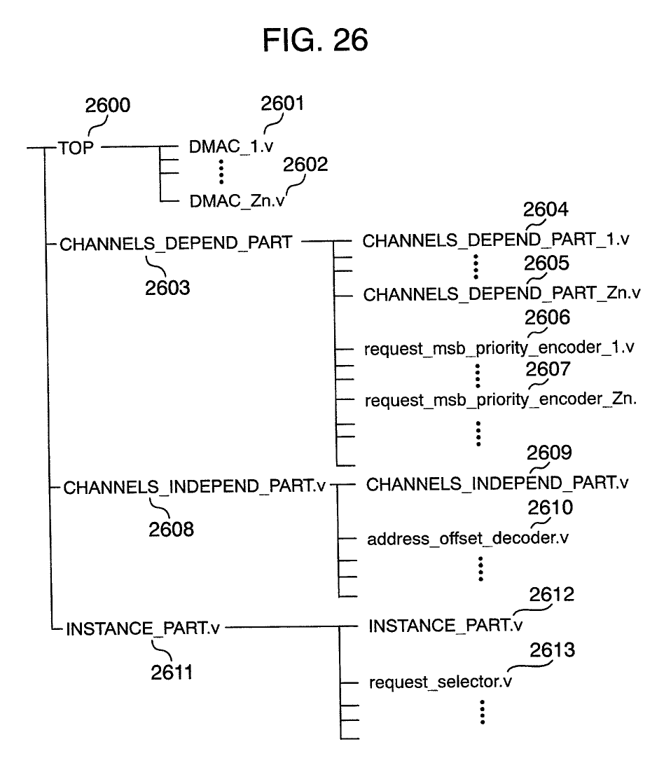

FIG. 26 is a diagram for indicating a directory structure of component data which is stored into the file storage apparatus 2501. The component data is constituted by a directory 2600 for storing logic files of a top hierarchy of the DMA controller; another directory 2603 for storing logic files of a channel number depending unit 300; another directory 2608 for storing logic files of a channel number not-depending unit 302; and another directory 2611 for storing logic files of an instance capable unit 301.

In the directory 2600, logic files (2601 to 2602) of the top hierarchy of the DMA controller are previously prepared with respect to a sort of channel numbers. In the directory 2603, logic files (2604 to 2607) of the respective circuits which constitute the channel number depending unit 300 are previously prepared with respect to the sort of channel numbers.

The sort (=Zn) of these channel numbers are added as suffices to both the respective logic files (2601 to 2602) of the top hierarchy of the DMA controller and also file names of the respective logic files (2604 to 2607) of the channel number depending unit 300. For instance, in the case of the channel number 1, symbol “_{—}1” is added to a file extension identifier to form a “DMA controller _{—}1.V” as to a logic file of the top hierarchy of the DMA controller.

The directory 2603 of the channel number depending unit 300 contains logic files of the following circuits. That is to say, the directory 2603 contains logic files as to: the top hierarchy of the channel number depending unit 300; the request priority encoder circuit 701; the top hierarchy of the acknowledge output circuit 702; the peripheral device acknowledge generating circuit 1000; the external device acknowledge generating circuit 1001; the top hierarchy of the control register selector grouping circuit 703; the respective selectors (1300 to 1308) of the control register selector grouping circuit 703; the top hierarchy of the control register RD/WR circuit 704; the channel decoder circuit 1401; the address decoder circuit 1402; the register RD/WR state machine circuit 1403; and also the DMA operation register 700.

The directory 2608 of the channel number not-depending unit 302 contains logic files of the following circuits. In other words, this directory 2608 contains the logic files as to: the top hierarchy of the channel number not-depending unit 302; the temporary buffer 1800; the transfer control state machine circuit 1801; the address offset decoder circuit 1802; the adder 1804; the decrementer 1805; the comparator 1806; and also the selector 1803. It should be noted that these logic files of the channel number not-depending unit 302 may be grouped as a single logic file.

The directory 2611 of the instance capable unit 301 contains logic files of the below-mentioned circuits. In other words, this directory 2611 contains the logic files as to: the top hierarchy of the instance capable unit 301; the request selector circuit 400; the channel control register 401; the transfer time register 402; the source address register 403; and also the destination address register 404. It should also be noted that these logic files of the instance capable unit 301 may be grouped as a single logic file.

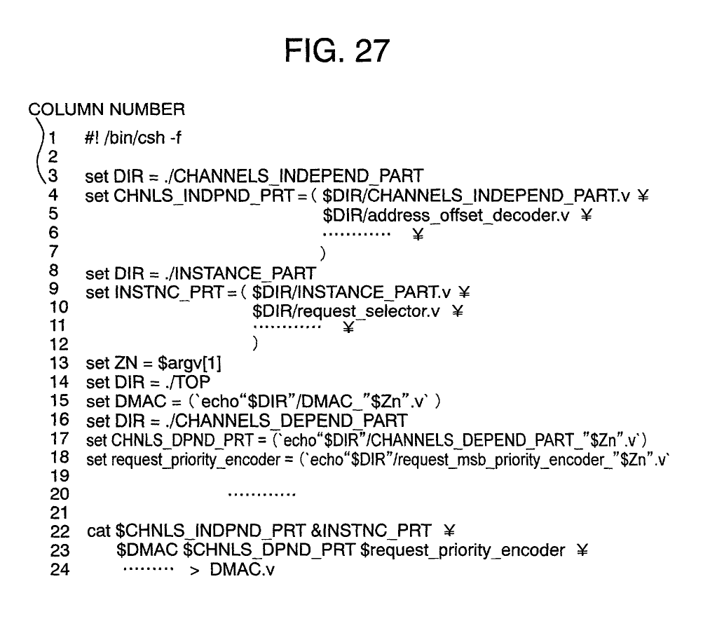

FIG. 27 is a diagram for indicating an example of a program of a shell command which is executed by the component coupling apparatus 2502. This program corresponds to such a program capable of automatically generating a logic file of a DMA controller of a channel number “Zn” in such a manner that in response to the channel number Zn designated by the parameter input apparatus 2500, the relevant logic file is read out from the file storage apparatus.

A first column of this program indicates that the program of FIG. 27 is executed by a C shell. In a third column to a seventh column of this program, a file path of each of the logic files of the channel number not-depending unit is set to a single shell variable CHNLS_INDPND_PRT. In an eighth column to a 12-th column of this program, a file path of each of the logic files of the instance capable unit 301 is set to a single shell variable INSTNC_PRT.

In a 13-th column of this program, a channel number designated by the parameter input apparatus 2500 is set to the shell variable Zn. In a 14-th column to a 15-th column of the program, a file path of a logic file of a top hierarchy of a DMA controller corresponding to the designated channel number is set to a shell variable DMA controller.

In a 17-th column and succeeding columns of the program, file paths of the respective logic files of the channel number depending unit 300 corresponding to the designated channel number are set to shell variables. In a 22nd column to a 24-th column of this program, while employing the respective shell variables to which file paths of logic files are set, all of logic files indicated by the shell variables are coupled to each other, and the file (DMA controller.V) is outputted to the file storage apparatus 2501.

When this automatic DMA controller generating apparatus is employed, the DMA controller having the desirable external device number, or the desirable channel number can be automatically generated. In this automatic DMA controller generating apparatus, in order that the peripheral device number may also be entered as a parameter, the logic file which depends upon the peripheral device number should be previously changed into the desirable peripheral device number, and the changed peripheral device number should be stored in the file storage apparatus 2501.

The following logic files depend upon the peripheral device number. In other words, these logic files are: the top hierarchy of the DMA controller; the top hierarchy of the channel number depending unit 300; the top hierarchy of the acknowledge output circuit 702; the peripheral device acknowledge generating circuit 1000; the top hierarchy of the instance capable unit 301; and also the request selector circuit 400.

Among these logic files, the logic files as to: the top hierarchy of the DMA controller; the top hierarchy of the channel number depending unit 300; and the top hierarchy of the acknowledge output circuit 702 are such circuits which may also depend on the external device number (namely, channel number). As a consequence, while a sort of predicted external device numbers is combined with a sort of predicted peripheral device numbers, logic files must be prepared.

In the below-mentioned embodiment mode 3, an automatic DMA controller generating apparatus is equipped with a component correcting apparatus for automatically correcting a logic file which depends upon a peripheral device number as a desirable peripheral device number.

Embodiment Mode 3

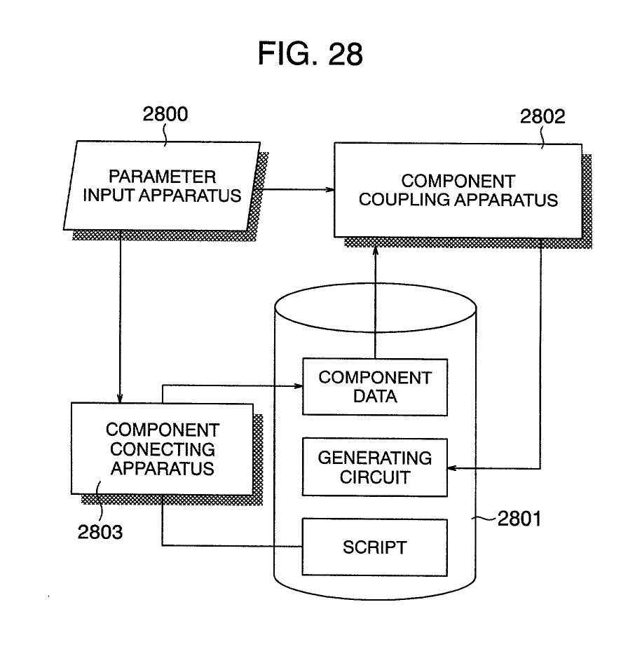

Referring now to FIG. 28 to FIG. 31, a description will be made of an arrangement and operation of an automatic DMA controller generating-apparatus of an embodiment mode 3, equipped with such a means capable of automatically changing a total number of external devices and also a total number of peripheral devices, employed in a DMA controller so as to achieve the above-described second object of the present invention.

FIG. 28 is a schematic block diagram for indicating a system arrangement of the automatic DMA controller generating apparatus according to this embodiment mode 3. This automatic DMA controller generating apparatus may be realized in the process system equipped with a memory and a CPU such as a workstation and a personal computer. This automatic DMA controller generating apparatus is constituted by a parameter input apparatus 2800, a file storage apparatus 2801, a component coupling apparatus 2802, and a component correcting apparatus 2803.

The parameter input apparatus 2800 is equipped with such a user interface. This user interface is used to input either a total number of external devices or a total number of channel numbers of a DAM controller which is wanted to be automatically generated. The file storage apparatus 2801 is provided with such a storage medium as a magnetic disk and a semiconductor memory. The component coupling apparatus 2802 couples the respective logic files of component data to each other so as to generate a logic file of the DMA controller. The component correcting apparatus 2803 corresponds to such an apparatus for executing a script in response to a peripheral device number instructed by the parameter input apparatus 2800 and thus, for producing component data.

In the file storage apparatus 2801 of the automatic DMA generating apparatus according to this embodiment mode 3, the below-mentioned logic files which depend upon the peripheral device number are prepared, namely, a top hierarchy of a DMA controller; a top hierarchy of a channel number depending unit 300; a top hierarchy of an acknowledge output circuit 702; a peripheral device acknowledge generating circuit 1000; and a top hierarchy of an instance capable unit 301. Also, with respect to a request selector circuit 400, a script file is prepared instead of a logic file in this file storage apparatus 2801. This script file describes commands which are processed by the component correcting apparatus 2803. A script file implies such a file that a program portion within an HDL program of a logic file is replaced by a command, and this program portion depends upon a peripheral device number.

With respect to the script files as to: the top hierarchy of the DMA controller; the top hierarchy of the channel number depending unit 300; and the top hierarchy of the acknowledge output circuit 702 are such circuits which may also depend on the external device number (namely, channel number). As a consequence, the script files must be prepared, the total number of which is equal to a sort of predicted external device numbers.

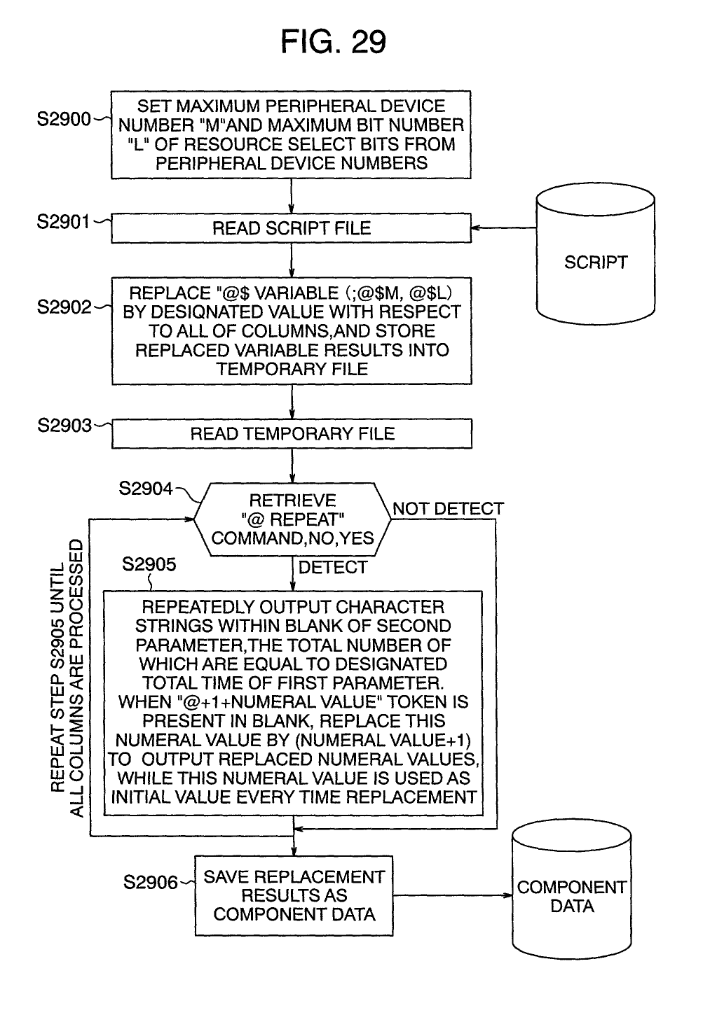

FIG. 29 is a flow chart for describing a process sequential operation executed by the component correcting apparatus 2803. The component correcting apparatus 2803 corresponds to such an apparatus operated in such a manner that when both a peripheral device number designated by the parameter input apparatus 2800 and a file path of a script file stored in the file storage apparatus 2801 are applied as an input, such a logic file of component data with respect to the designated peripheral device number is generated. The component correcting apparatus 2803 may correct such a token whose character is “@.” The correction process operation of the component correcting apparatus 2803 is carried out as follows: That is, firstly, a value is set to a maximum peripheral device number M (=total peripheral device number −1) which can be calculated from the designated peripheral device number, and a value is set to a maximum bit number “L” of a resource select bit RS[L:0] which can be calculated based upon the formula (1) (step S2900). For example, in the case that a total number of these peripheral devices is equal to 7, the maximum peripheral device number M is set to “6”, whereas the maximum bit number “L” of the resource select bit is set to “2.” Next, the designated script file is read (step S2901). With respect to all of the columns, both a program portion which is described by symbol “@$M”, and another program portion which is described by symbol “@$L” are substituted by both the value which is set to the maximum peripheral device number M and the value which is set to the maximum bit number of the resource select bit, and thereafter, these substituted values are temporarily stored in the temporary file (step S2902).

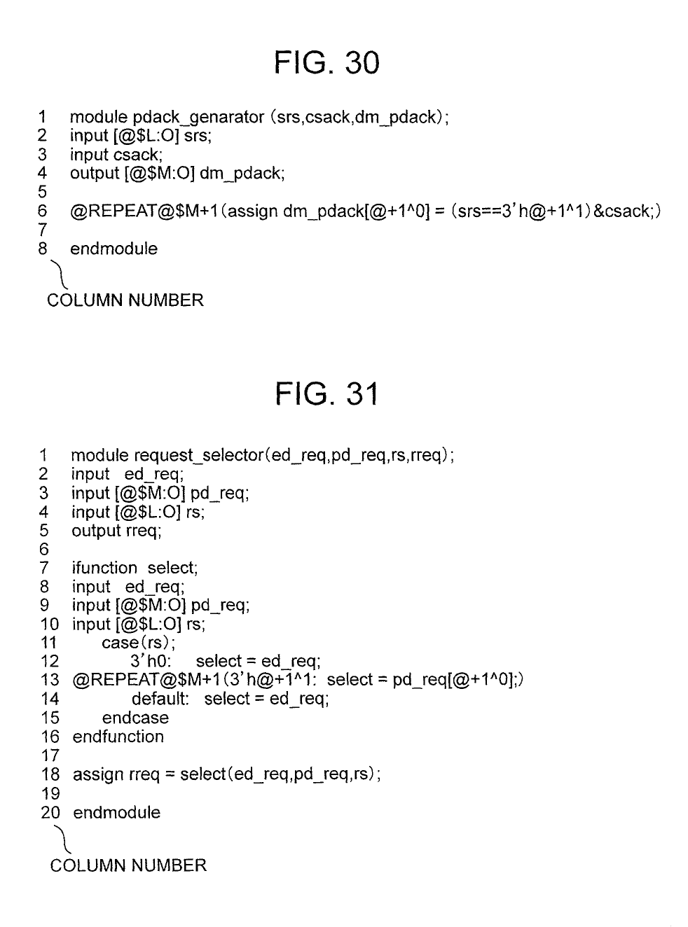

FIG. 30 is a diagram for indicating an example of such a script used to generate a logic file of the peripheral device acknowledge generating circuit 1000. In the case of the script shown in FIG. 30, symbol “@$L” in a second column is replaced by “2”, and symbol “@$M” in a fourth column and a sixth column is replaced by “6”, and the replaced commands are stored in the temporary file. Next, the content of the temporary file is read (step S2903), and such a command “@REPEAT” is retrieved with respect to the respective columns contained in the temporary file (step S2904). If there is no command “@REPEAT” in this temporary file, then no process operation is carried out. To the contrary, when such a command “@REPEAT” is present, a character string which is surrounded by “(“and ”)” of a second argument thereof is repeatedly outputted plural times equal to a designated total time of a first argument thereof.

In this case, in such a case that a token of “@+1 numeral value” is detected in the character string, every time the portion of “@+1 numeral value” is repeatedly outputted while a numeral value contained in the token is employed as an initial value, this portion is replaced by a value added by “1”, and then the resulting character string is outputted (step S2905). For example, in the previous example, in a command “@REPEAT” in the sixth column, since a portion “@$M+1” of the first argument is replaced by “6+1”, a statement “assign” described between “(∂and ”)” is repeatedly outputted seven times. In this case, while “0” is employed as the initial value, every time a portion “@+1ˆ 0” is repeatedly outputted, this portion is incremented to be outputted, and while “1” is employed as the initial value, every time another portion “@+1ˆ 1” is repeatedly outputted, this portion is incremented to be outputted.

When the script example shown in FIG. 30 is processed by the component correcting apparatus 2803, such an HDL program of the peripheral device acknowledge generating circuit 1000 is generated in the case that a total number of the peripheral devices shown in FIG. 11 is equal to 7.

FIG. 31 is a diagram for representing an example of a script which is used to generate a logic file of the request selector circuit 400. When the script example of FIG. 31 is processed, the HDL program of the request selector circuit 400 shown in FIG. 6 is generated. Finally, the process result is stored into the file storage apparatus 2801 as the logic file of the component data (step S2906).

In this automatic DMA control generating apparatus, when both a total number of external devices and a total number of peripheral devices are entered by the parameter input apparatus 2800, the component correcting apparatus 2803 first executes a script file of the relevant circuit with respect to such a circuit which depends upon the total peripheral device number, and converts the executed script file into a logic file so as to store this logic file as the component data. Then, similar to the process operation of the embodiment mode 2, the component coupling apparatus 2802 reads the relevant logic file from the file storage apparatus 2801 in response to the designated external device number (namely, channel number), and thus, automatically produces such a logic file of the DMA controller having the designated external device number and the designated peripheral device number.

If the automatic DMA controller generating apparatus is employed, then the DMA controller having the desirable external device number and the desirable peripheral device number can be automatically generated. In this embodiment mode 3, with respect to the circuit which depends upon the peripheral device number, the script file is prepared and then is converted into the logic file. Similarly, with respect to the respective circuits which constitute the channel number depending unit 300, while such a script file is prepared in which a file portion depending upon a total channel number is made of a command this script file may be apparently converted into a logic file.

When a program capable of executing the process operation of the component correcting apparatus 2803 is formed, a shell command of the UNIX, and also such a syntax analysis program forming tool as “yacc” and “lex” of a utility program are employed. This utility program is provided by the UNIX.

Embodiment Mode 4

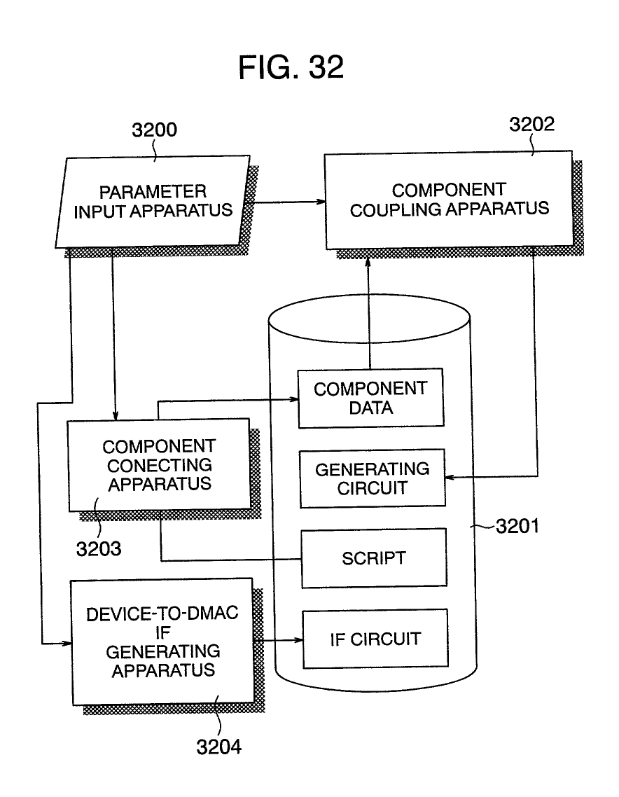

Referring now to FIG. 32 to FIG. 39, a description will be made of an arrangement and operation of an automatic DMA controller generating apparatus of an embodiment mode 4, equipped with such a means capable of automatically changing a total number of external devices and also a total number of peripheral devices, employed in a DMA controller so as to achieve the above-described second object of the present invention.

In the DMA controller of the embodiment mode 1, the priority orders of the channels which accept the data transfer requests of the external devices are defined by channel Z>channel Z-1>, - - - , >channel 1>channel 0. In other words, such external devices which are connected to channels whose channel numbers are large own higher priority orders. As a consequence, a user is required to connect which external device to which channel, while paying his attention to the connection relationship. In general, there are various names of request signal lines for data transfers, and also various names of acknowledge signals with respect to DMA controllers, depending upon chips to which these DMA controllers are applied.

The automatic DMA generating apparatus of this embodiment mode 4 may provide such a function capable of generating an interface circuit between an external device and a DMA controller in addition to the function of the automatic DMA generating apparatus of the embodiment mode 3. Also, this automatic DMA controller generating apparatus may provide a function capable of selecting priority orders of channels.

FIG. 32 is a schematic block diagram for indicating a system arrangement of the automatic DMA generating apparatus according to this embodiment mode 4. This automatic DMA controller generating apparatus is constituted by a parameter input apparatus 3200, a file storage apparatus 3201, a component coupling apparatus 3202, a component correcting apparatus 3203, and an interface circuit generating apparatus 3204 for interfacing a device and a DMA controller. The parameter input apparatus 3200 corresponds to such an apparatus including a graphical user interface (GUI) used to input a parameter related to such a DMA controller which is wanted to be automatically generated. The file storage apparatus 3201 is an apparatus provided with such a storage medium as a magnetic disk and a semiconductor memory. The component coupling apparatus 3202 is an apparatus which couples the respective logic files of component data to each other so as to generate a logic file of the DMA controller. The component correcting apparatus 3202 is such an apparatus similar to that of the embodiment mode 3. The interface circuit generating apparatus 3204 for interfacing the device with the DMA controller corresponds to such an apparatus. That is, this apparatus automatically generates a logic file of an interface circuit among a DMA controller, an external device, and a peripheral device based upon information entered from the parameter input apparatus 3200.

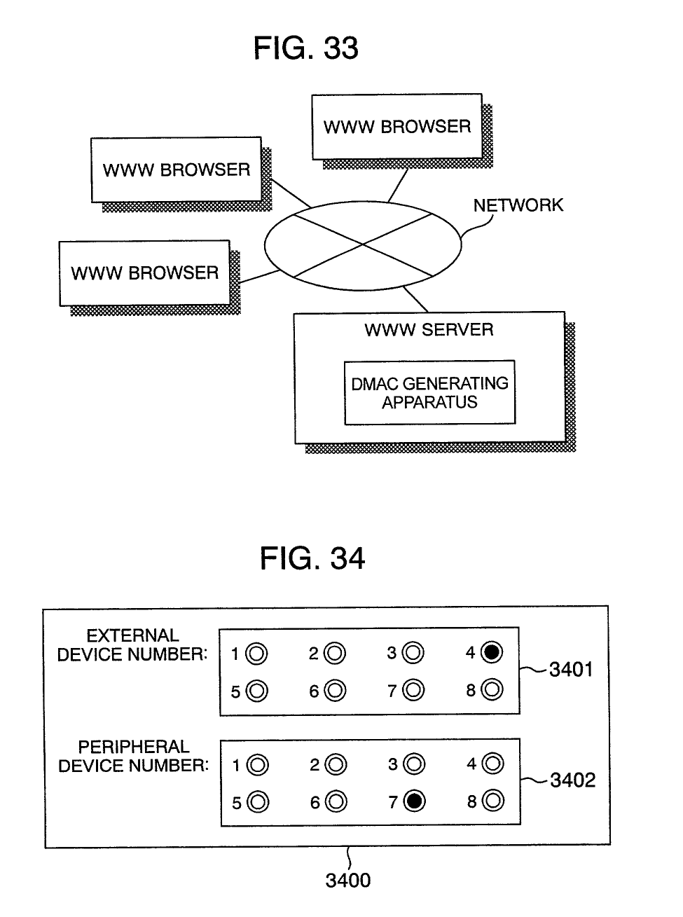

FIG. 33 is a diagram for schematically showing an example of a system environment used to suitably realize the automatic DMA controller generating apparatus according to this embodiment mode 4. A program capable of realizing the function of this automatic DMA controller generating apparatus is installed inside a WWW server. The GUI provided by the parameter input apparatus 3200 is described by using such a programming language as HTML (Hyper Text Make up Language) and Java, which may be processed by the WWW browser. A program which may embody the function of the component coupling apparatus 3202, the function of the component correcting apparatus 3203, and the function of the interface circuit generating circuit 3204 for interfacing between the device and the DMA controller is executed from a program of the parameter input apparatus 3200, while using the function of the CGI provided by the WWW server.

FIG. 34 is a diagram for illustratively showing an example of a GUI screen 3400 used to enter both external device numbers and peripheral device numbers, which are provided by the parameter input apparatus 3200. The GUI screen 3400 is constituted by a radio button area 2301 and another radio button area 3402. In this radio button area 3401, a plurality of radio buttons are prepared, the total number of which is equal to a total sort number of predicted external device numbers. In the radio button area 3402, a plurality of radio buttons are prepared, the total number of which is equal to a total sort number of predicted peripheral device numbers.

The radio buttons correspond to a plurality of not-selectable buttons. When one radio button is selected, a color of this radio button is reversed so as to clarify such a fact that this radio button is selected. Labels attached to these radio buttons indicate sorts of device numbers. In the example of FIG. 34, the total external device number is selected to be 4, and the total peripheral device number is selected to be 7.

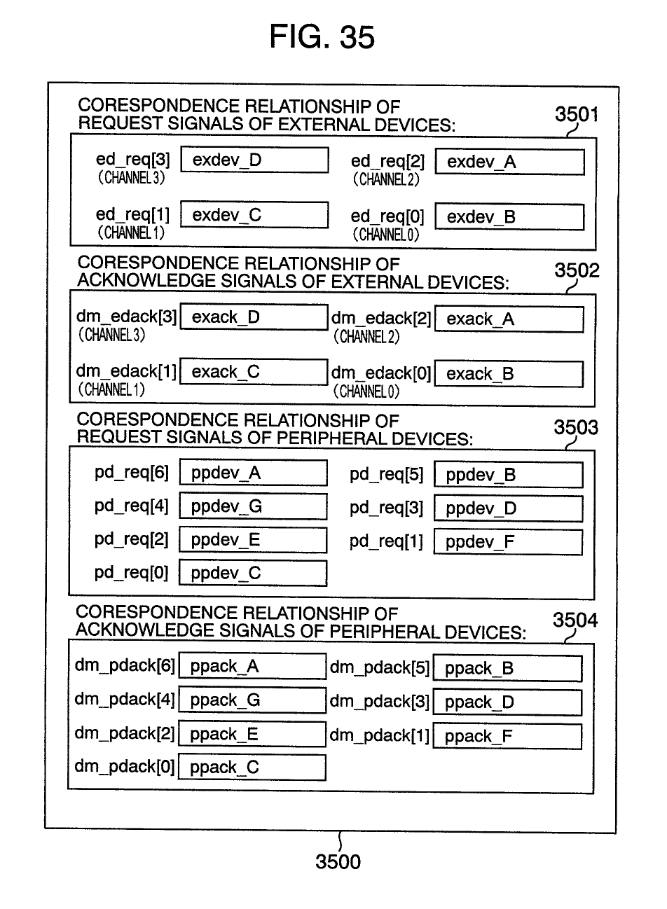

FIG. 35 is a diagram for representing an example of a GUI screen by which signals may be related between devices provided by the parameter input apparatus 3200 and the DMA controller. This GUI screen 3500 is constituted by a text field area 3501, another text field area 3502, another text field area 3503, and a further text field area 3504. The text field area 3501 may cause data transfer request signals to be related between external devices and the DMA controller. The text field area 3502 may cause data transfer acknowledge signals to be related between external devices and the DMA controller. The text field area 3503 may cause data transfer request signals to be related between peripheral devices and the DMA controller. The text field area 3504 may cause data transfer acknowledge signals to be related between peripheral devices and the DMA controller.

In the GUI screen 3500, text fields, the total number of which is equal to a total number of these external devices designated by the GUI screen 3400, are displayed within both the text field area 3501 and the text field area 3502.

Also, in the GUI screen 3500, text fields, the total number of which is equal to a total number of these peripheral devices designated by the GUI screen 3400, are displayed within both the text field area 3503 and the text field area 3504. An arbitrary character string may be entered into the text field, and signal line names on the device side corresponding to the signal line names of the DMA controller 207 are entered. Labels attached to the text field correspond to signal line names of the DMA controller 207.

In the GUI screen 3500 of this embodiment mode 4, bit numbers (to be displayed) of signal lines of the DMA controller 207 are outputted in the descent order in order that logic files of interface circuits between devices and DMA controllers can be readily produced. When such a bit number output order is determined, names of signal lines may be simply written in the display order within a connecting statement of the HDL. A connecting statement corresponds to such a description used to group independent signal lines as a single signal line. For example, when the relationship between the external devices and the data transfer request signals shown in FIG. 35 is expressed by the connecting statement of the HDL, this relationship is given as follows:

assign ed_req={exdev_D, exdev_A, exdev_C, exdev_B };

As a consequence, if the input results are merely and additionally written into the connecting statement in the display order, then the bit lines of the signal lines must be displayed in the descent order.

Next, a description will now be made of operations of the interface circuit generating apparatus 3204 between the devices and the DMA controller.

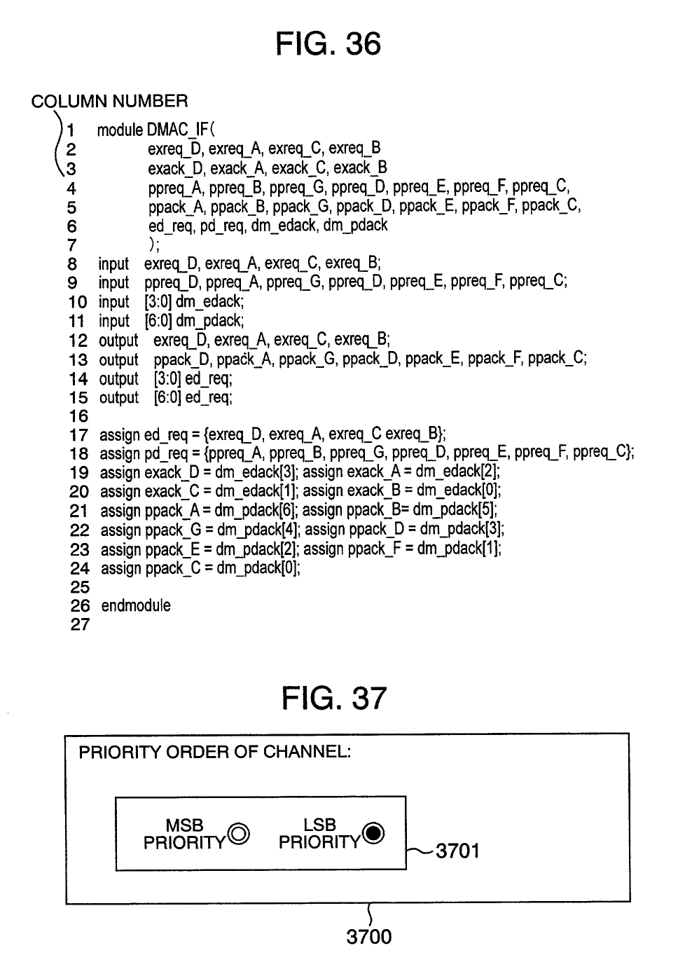

FIG. 36 is a diagram for indicating an example of an HDL program of the interface circuit between the devices and the DMA controller, which is produced by the interface circuit generating apparatus 3204 between the devices and the DMA controller based upon the input information shown in FIG. 34 and FIG. 35. First, in order to form a “module” statement of an interface circuit DMAC_IF between the devices and the DMA controller, the interface circuit generating apparatus 3204 between the devices and the DMA controller sequentially and additionally writes both the data transfer request signals and the data transfer acknowledge signals of the external devices, which are entered in FIG. 35, and both the data transfer request signals and the data transfer acknowledge signals of the peripheral devices, which are entered in FIG. 35, into a port list of the “module” statement in the order shown in FIG. 35. For example, a second column to a seventh column represent the written results in FIG. 36.

In a port declaration of an input port, the data transfer request signals of the external devices and the peripheral devices, which are entered in FIG. 35, are additionally written in the display order. In FIG. 36, an eighth column to a ninth column correspond to the written results.

Similarly, in the port declaration of the input port, both a maximum bit number of the external devices and a maximum bit number of the peripheral devices are calculated from the external device numbers and also the peripheral device numbers are acquired. The resulting maximum bit numbers are described in a bit-width of a data transfer acknowledge signal dm_edack of an external device, and also a bit-width of a data transfer acknowledge signal dm_pdack of a peripheral device, which are employed in the DMA controller 207. In FIG. 36, a tenth column to an eleventh column correspond to the described results.

Next, in a port declaration of an output port, the data transfer request signals of the external devices and the peripheral devices, which are entered in FIG. 35, are additionally written in the display order. In FIG. 36, a 12-th column to a 13-th column correspond to the written results.

Similarly, in the port declaration of the output port, both maximum bit numbers of the external device and the peripheral device are described in a bit-width of a data transfer request signal ed_req of an external device and also in a bit-width of a data transfer request signal pd_req of a peripheral device, which are employed in the DMA controller 207. In FIG. 36, a 14-th column to a 15-th column correspond to the described results.

Next, with respect to the data transfer request signals of the external device and the peripheral device, which are inputted in FIG. 35, both the data transfer request signal ed_req of the external device and the data transfer request signal pd_req of the peripheral device, which are employed in the DMA controller 207, are entered by employing the connecting statements, respectively. The signals are additionally described in the connecting sentences in the display order of FIG. 35. I FIG. 36, a 17-th column to an 18-th column correspond to the described results.

The data transfer acknowledge signal dm_edack of the DMA controller 207 is connected to the data transfer acknowledge signals of the external devices inputted in FIG. 35 by employing an “assign” statement. In this case, the data transfer acknowledge signals appeared on the device side are described in the display order of FIG. 35, whereas the data transfer acknowledge signals provided on the side of the DMA controller 207 are described in the descent order. This description is similarly applied also to the peripheral devices. In FIG. 36, a 19-th column to a 24-th column correspond to the described results.

Finally, an “endmodule” statement is described, and then, the resulting statement is stored in the file storage apparatus 3201 as the logic file of the interface circuit between the device and the DMA controller.

FIG. 37 is a diagram for representing an example of such a GUI screen used to designate priority orders of channels which are provided by the parameter input apparatus 3200. The GUI screen 3700 is constituted by a radio button area 3701 which is used to designate the priority orders of the channels. The radio button area 3701 is arranged by a radio button of “MSB priority” and another radio button of “LSB priority.” This radio button of “MSB priority” makes such a designation that the larger the channel number becomes, the higher the priority order of the channel is designated. The radio button of “LSB priority” makes such a designation that the smaller the channel number becomes, the higher the priority order of the channel is designated. While the radio button of “LSB priority” is selected in the example of FIG. 37, such a designation is made. That is, the circuit operated in such a manner that the smaller the channel number becomes, the higher the priority order of the channel is designated is assembled.

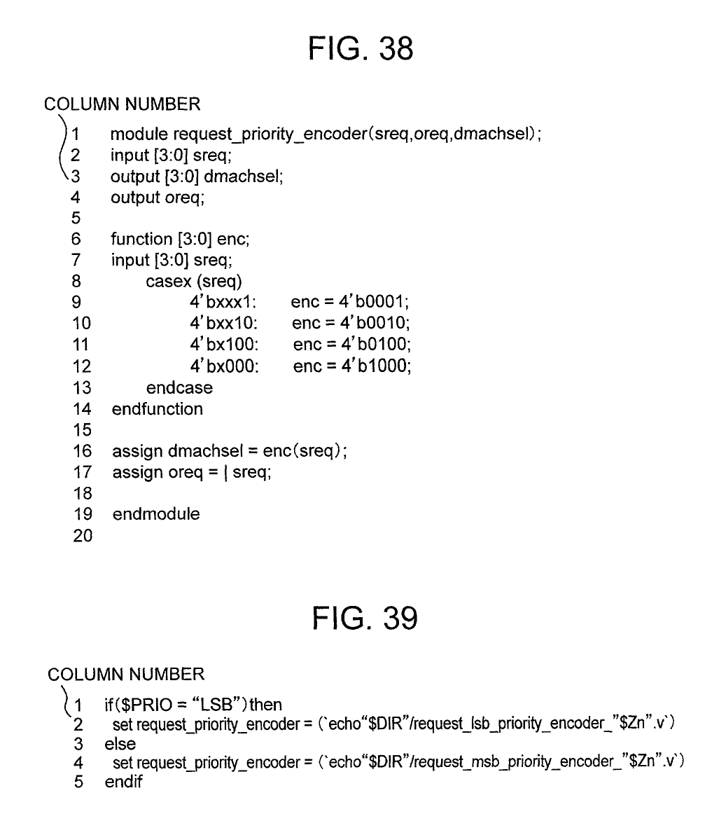

FIG. 38 is a diagram for representing an example (LSB priority) of an HDL program of the request priority encoder circuit 701 in the case that a total number (=Z+1) of these external devices is equal to 4. It should be noted that FIG. 9 was the example of the HDL program of the request priority encoder circuit having the “MSB priority.”

Operations executed in this automatic DMA controller generating apparatus are similar to those of the embodiment mode 2 and the embodiment mode 3, and further, a directory structure of component data is basically similar to the directory structure shown in FIG. 26.

However, in the directory structure of the component data according to this embodiment mode 4, a logic file of the request priority encoder circuit 701 having the “LSB priority” is present in the directory 2603 for storing thereinto the logic file of the channel number depending unit 300 (request_{—}1sb_priority_encoder_{—}1.v˜request_{—}1sb_priority_encoder_Zn.v).

In accordance with this automatic DMA controller generating apparatus, when an external device number and a peripheral device number are inputted on the GUI screen 3400 provided by the parameter input apparatus 3200, first of all, the component correcting apparatus 3203 executes a script file of the relevant circuit so as to convert the executed script file into a logic file, and then, stores the logic file as component data with respect to such a circuit which depends upon the peripheral device number.

In response to the designated external device number (namely, channel number), this component coupling apparatus 3202 reads out the relevant logic file from the file storage apparatus 3201. At this time, the component coupling apparatus 3202 reads out either the logic file of the request priority encoder circuit 701 having the “LSB priority” or the logic file of the request priority encoder circuit 701 having the “MSB priority” in accordance with the designation of the priority order of the channels made on the GUI screen 3700.

FIG. 39 is a diagram for showing an example of a program of a shell command which is used to select either a request priority encoder circuit having “LSB priority” or a request priority encoder circuit having “MSB priority.” This operation may be executed if, for example, the shell command shown in FIG. 39 is employed instead of the 18-th column of FIG. 27, and thus, the logic files of the DMA controller having the designated external device number and the designated peripheral device number may be automatically generated.

Also, in this automatic DMA controller generating apparatus, the interface circuit generating apparatus 3204 between the device and the DMA controller may automatically generate the logic files of the interface circuit between the devices and the DMA controller based upon the input information of both the GUI screen 3400 and the GUI screen 3500, which is provided by the parameter input apparatus 3200, in accordance with the previously explained operations.

As previously described in detail, the DMA controller 207 of the present invention is arranged by being separated into the three sorts of functional blocks, namely the channel number not-depending unit 302 constituted by the circuits which do not depend upon the channel number; the instance capable unit 301 which is constituted by the circuits which do not depend upon the channel number, but are repeatedly used plural times equal to a total number of these channels; and also the channel number depending unit 300 containing the circuits which depend upon the channel number. As a consequence, even in such a case that a total number of these channels is increased/decreased in response to a change in a total number of these external devices, only the HDL program of the top hierarchy of the channel number depending unit 300 and also the HDL program of the top hierarchy of the DMA controller 207 may be merely corrected. As a result, even when the HDL programs are corrected by way of the manual correction work, the channel number can be readily changed.

Also, since the circuit which depends upon the device number is clearly discriminated from the circuit which does not depend upon the device number, either the logic file or the script file can be previously prepared as the component data only with respect to the circuit which depends upon the device number, and also, the logic files of the DMA controller with respect to the desirable device number can be easily and automatically generated.

Furthermore, while both the relevant channel number depending unit 300 and the logic file of the top hierarchy are selected in response to a desirable total number of external device, the automatic DMA controller generating apparatus is provided with the component coupling apparatus 2502 for coupling the instance capable unit 301 with the logic file of the channel number not-depending unit 302. As a consequence, the logic file of the DMA controller having the desirable total number of these external devices can be automatically generated.

Also, this automatic DMA controller generating apparatus is provided with the component correcting apparatus 2803 which forms the logic file from the script file of the circuit which depends upon the peripheral device number in response to a desirable number of these peripheral devices. As a consequence, the logic file of the DMA controller having the desirable total number of these external devices can be automatically generated.

Furthermore, with respect to the chip to which the DMA controller is applied, the logic file of the interface circuit between the device and the DMA controller is combined with the logic file of the DMA controller and then, the combined logic file is provided, while the logic file of the interface circuit is generated by such an interface circuit generating apparatus between the DMA controller and the device based upon the correspondence information as to the signals among the devices and the DMA controller entered by the parameter input apparatus 3200, and also, the logic file of the DMA controller is generated by the component coupling apparatus 3202 based upon the information as to the priority order of the channels inputted by the parameter input apparatus 3200. As a consequence, the chip can have the desirable channel priority order, and the circuits corresponding to the signal line names of this chip can be provided.

What is claimed is:

1. A DMA controller for transferring data between a device connected to either an external bus or an internal bus, and a memory area, comprising:
a channel number depending circuit block for handling a signal related to the number of channels in the case that both a data transfer request signal sent from said device and a data transfer acknowledge signal corresponding to an response signal thereof are connected;
an instance capable circuit block which can be repeatedly used plural times equal to a total number of said channels; and
a channel number not-depending circuit block.

2. A DMA controller as claimed in claim 1 wherein:
said channel number depending circuit block includes:
a request priority encoder circuit for selecting a request of a channel whose priority order is high;
an acknowledge output circuit of controlling said data transfer acknowledge signal;
a selector circuit for selecting either a data bus or a control signal, which depends upon the channel number;
a state machine circuit for controlling a data access operation with respect to a control register employed in the DMA controller;
a decoder circuit for decoding an address bus signal when said data access operation is carried out; and
a DMA operation register circuit for controlling an entire circuit of said DMA controller.

3. A DMA controller as claimed in claim 1 wherein:
said instance capable circuit block includes:
a request selector circuit for selecting one of the data transfer request signals issued from a plurality of devices as a signal used for a DMA transfer operation; and
a control register group of the DMA controllers which are required, the total number of which is equal to the total channel numbers.

4. A DMA controller as claimed in claim 2 wherein:
said instance capable circuit block includes:
a request selector circuit for selecting one of the data transfer request signals issued from a plurality of devices as a signal used for a DMA transfer operation; and
a control register group of the DMA controllers which are required, the total number of which is equal to the total channel numbers.

5. A DMA controller as claimed in claim 3 wherein:
said control register group of the DMA controller is comprised of:
a channel control register for controlling a data transfer operation of the DMA controller with respect to each of the channels;
a transfer time register for decrementing of said DMA controller so as to count the data transfer time;
a source address register for representing a transfer source address used in the data transfer operation of the DMA controller; and
a destination address register for representing a transfer destination address used in the data transfer operation of the DMA controller.

6. A DMA controller as claimed in claim 4 wherein:
said control register group of the DMA controller is comprised of:
a channel control register for controlling a data transfer operation of the DMA controller with respect to each of the channels;
a transfer time register for decrementing of said DMA controller so as to count the data transfer time;
a source address register for representing a transfer source address used in the data transfer operation of the DMA controller; and
a destination address register for representing a transfer destination address used in the data transfer operation of the DMA controller.

7. A DMA controller as claimed in claim 1 wherein:
said channel number depending circuit block includes:
a register for temporarily holding data which is read from a transfer source during the DMA transfer operation;
a state machine circuit for controlling the data transfer operation of the DMA controller;
an address offset decoder circuit for determining an address increase amount of a transfer source address and an address increase amount of a transfer destination address during the DMA transfer operation;
an adder for calculating both a transfer source address and a transfer destination address during the DMA transfer operation;
a decrementer for decrementing a data transfer time of the DMA controller; and
a comparator for comparing a content of the transfer time register with “0” in order to assert a transfer end interrupt of the DMA controller.

8. A DMA controller as claimed in claim 2 wherein:
said channel number depending circuit block includes:
a register for temporarily holding data which is read from a transfer source during the DMA transfer operation;
a state machine circuit for controlling the data transfer operation of the DMA controller;
an address offset decoder circuit for determining an address increase amount of a transfer source address and an address increase amount of a transfer destination address during the DMA transfer operation;
an adder for calculating both a transfer source address and a transfer destination address during the DMA transfer operation;
a decrementer for decrementing a data transfer time of the DMA controller; and
a comparator for comparing a content of the transfer time register with “0” in order to assert a transfer end interrupt of the DMA controller.

9. A method for generating a DMA controller used to transfer data between a device connected to either an external bus or an internal bus and a memory area, wherein:
a channel number depending unit for handling a signal related to the number of channels is extracted from each functional block of a component data logic file of a DMA controller;
an instance capable unit which can be repeatedly used plural times equal to a total number of said channels is extracted;
a channel number not-depending unit is extracted; and
a logic file of said channel number depending unit, a logic file of said instance capable unit, a logic file of said channel number not-depending unit are coupled to each other so as to generate a logic file of said DMA controller.

10. An apparatus for generating a DMA controller used to transfer data between a device connected to either an external bus or an internal bus and a memory area, comprising:
a parameter input apparatus equipped with a user interface used to enter either a total number of channels, or a total number of devices of a DMA controller which are wanted to be automatically generated;
a file storage apparatus for storing thereinto logic files of component data of each of circuits and a generated logic file; and
a component coupling apparatus for coupling the logic files of the component data with each other based upon input information from the parameter input apparatus so as to automatically generate a logic file of the DMA controller.

11. An apparatus for generating a DMA controller used to transfer data between a device connected to either an external bus or an internal bus and a memory area, comprising:
a parameter input apparatus equipped with a user interface used to enter either a total number of channels, or a total number of devices of a DMA controller which are wanted to be automatically generated;
a file storage apparatus for storing thereinto both logic files of component data of each of circuits and also a script file which automatically generates a logic file;
a component coupling apparatus for coupling the logic files of the component data with each other based upon input information from the parameter input apparatus so as to automatically generate a logic file of the DMA controller; and
a component correcting apparatus for automatically generating a logic file from a script file based upon input information from said parameter input apparatus.

12. A DMA controller generating apparatus as claimed in claim 10 wherein:
said parameter input apparatus is comprised of:
a GUI screen for designating a total number of devices which request to transfer data;
another GUI screen for causing signal lines between the devices and the DMA controllers to be related to each other; and
another GUI screen for setting priority orders of such channels which accept data transfer requests.

13. A DMA controller generating apparatus as claimed in claim 11 wherein:
said parameter input apparatus is comprised of:
a GUI screen for designating a total number of devices which request to transfer data;
another GUI screen for causing signal lines between the devices and the DMA controllers to be related to each other; and
another GUI screen for setting priority orders of such channels which accept data transfer requests.

14. A DMA controller generating apparatus as claimed in claim 12 wherein:
said DMA controller generating apparatus is further comprised of:
an interface generating apparatus for automatically generating a logic file of the interface circuit between the device and the DMA controller based upon the relationship information of the signal lines between the device and the DMA controller, which is entered from said parameter input apparatus.

15. A DMA controller generating apparatus as claimed in claim 13 wherein:
said DMA controller generating apparatus is further comprised of:
an interface generating apparatus for automatically generating a logic file of the interface circuit between the device and the DMA controller based upon the relationship information of the signal lines between the device and the DMA controller, which is entered from said parameter input apparatus.

16. A DMA controller generating apparatus as claimed in claim 12 wherein:
said GUI screen for setting the priority orders of the channels which accept the data transfer requests is equipped with:
selection means capable of setting such a condition that a data transfer request of such a device owns a higher priority order, said device being connected to a channel whose channel number is large, whereas a data transfer request of such a device owns a higher priority order, said device being connected to a channel whose channel number is small.

17. A DMA controller generating apparatus as claimed in claim 13 wherein:
said GUI screen for setting the priority orders of the channels which accept the data transfer requests is equipped with:
selection means capable of setting such a condition that a data transfer request of such a device owns a higher priority order, said device being connected to a channel whose channel number is large, whereas a data transfer request of such a device owns a higher priority order, said device being connected to a channel whose channel number is small.

18. A DMA controller generating apparatus as claimed in claim 12 wherein:
said parameter input apparatus owns a logic file of a request priority encoder circuit in response to a total sort number of the priority orders of the channels which are provided on the GUI screen for setting the priority orders of the channels which accept the data transfer requests.

19. A DMA controller generating apparatus as claimed in claim 13 wherein:
said parameter input apparatus owns a logic file of a request priority encoder circuit in response to a total sort number of the priority orders of the channels which are provided on the GUI screen for setting the priority orders of the channels which accept the data transfer requests.

20. A DMA controller generating apparatus as claimed in claim 12 wherein:
in said GUI screen for causing the signal lines between the deices and the DMA controllers to be related to each other,
names of signal lines provided on the side of said DMA controller are described in a descent order in accordance with a display order of a input column into which signal lines provided on the side of the devices are entered.
